(19) United States
(12) Patent Application Publication
(10) Pub. No.: US 2017/0136414 A1
(43) Pub. Date: May 18, 2017

(54) WATER TREATMENT METHOD, WATER TREATMENT SYSTEM, AND WATER TREATMENT APPARATUS

(71) Applicant: Kabushiki Kaisha Toshiba, Minato-ku (JP)

(72) Inventors: Tomohito IDE, Inagi (JP); Kenji Sano, Tokyo (JP); Toshihiro Imada, Kawasaki (JP)

(73) Assignee: Kabushiki Kaisha Toshiba, Minato-ku (JP)

(21) Appl. No.: 15/420,881

(22) Filed: Jan. 31, 2017

Related U.S. Application Data
(63) Continuation of application No. PCT/JP2015/081201, filed on Nov. 5, 2015.

(30) Foreign Application Priority Data
Nov. 7, 2014 (JP) 2014-227378
Mar. 20, 2015 (JP) 2015-057923

(51) Int. Cl. B01D 61/58; C02F 1/44; B01D 71/02; B01D 61/36; B01D 61/00

(52) U.S. Cl. CPC B01D 61/58; B01D 61/362; B01D 61/005; B01D 71/028; C02F 1/445; C02F 2103/08

(57) ABSTRACT

According to one embodiment, a water treatment method is a method configured to use a working medium that includes a draw solution and a water-containing solution to be treated. The draw solution is a hyperosmotic solution which generates an osmotic pressure difference with water. The method includes generating a flux of a mixture of water and a draw solution by an osmotic pressure difference generated between a solution to be treated and the draw solution in an osmotic pressure generator compartmentalized by an osmosis membrane, transferring the flux of the mixture to a vaporization-separation unit, separating the mixture into the water and the draw solution by a pressure difference, and recycling the draw solution separated by the vaporization-separation unit.

### CROSS REFERENCE TO RELATED APPLICATIONS

This application is a Continuation application of PCT Application No. PCT/JP2015/081201, filed Nov. 5, 2015 and based upon and claiming the benefit of priority from Japanese Patent Applications No. 2014-227378, filed Nov. 7, 2014; and No. 2015-057923, filed Mar. 20, 2015, the entire contents of all of which are incorporated herein by reference.

### FIELD

Embodiments described herein relate generally to a water treatment method, a water treatment system, and a water treatment apparatus.

### BACKGROUND

When a solution having low concentration and another solution having high concentration are separated via an osmosis membrane, the solvent of the solution having low concentration permeates through the osmosis membrane and transfers to the side of the solution having high concentration. An osmotic pressure power generation apparatus, which generates power by rotating the turbine by utilizing this solvent transfer phenomenon, has been known.

There is another type of osmotic pressure power generation apparatus, i.e., a circulatory osmotic pressure power generation apparatus which generates power by circulating a working medium within a closed system. For example, an power generation apparatus, which uses an ammonium carbonate aqueous solution as a working medium, is known. In this apparatus, the turbine is rotated by water flow created by the difference in osmotic pressure between two types of ammonium carbonate aqueous solutions of having different concentrations from each other. After rotating the turbine, the ammonium carbonate aqueous solutions are heated for recycling and are separated into gas (carbon dioxide and ammonia) and an ammonium carbonate aqueous solution having a very low concentration. The separated carbon dioxide gas and ammonia gas are reintroduced into water. Thus, ammonium carbonate aqueous solutions having a high concentration are obtained. The obtained two types of ammonium carbonate aqueous solutions having different concentrations are re-circulated and used for power generation.

Ammonium carbonate is highly soluble such that 100 g thereof dissolves in 100 mL of water at an ordinary temperature. Thus, an osmotic pressure capable of sucking fresh water from sea water (3.5 wt %) is given. Thereafter, ammonium carbonate is decomposed into carbon dioxide gas and ammonia gas at only 60° C.

In the osmotic pressure electric power generating apparatus which uses an ammonium carbonate aqueous solution, the osmotically-pressed ammonium carbonate aqueous solution is transferred to the turbine, thereby generating power. It is also possible to generate a pressure of 250 atm by application of osmotic pressure. This pressure is about 10 times as high as the pressure produced by osmosis power generation using the osmotic pressure of sea water.

On the other hand, in the case of osmosis power generation using ammonium carbonate, the inside of the system is deteriorated by generation of toxic and corrosive ammonia gas, which leads to a considerable impact on operation cost. Further, ammonium carbonate easily precipitates. For example, 6M ammonium carbonate precipitates immediately at less than 50° C. Thus, when the temperature near the osmosis membrane is decreased, there is a risk that the osmosis membrane is damaged by the precipitated crystals. This is a possible risk, particularly when performing maintenance at room temperature. In order to reduce the risk of precipitation, it is necessary to perform operation at low concentration. As a result, it becomes difficult to generate sufficient osmotic pressure.

### BRIEF DESCRIPTION OF THE DRAWINGS

FIG. 1 is diagram showing an osmotic pressure power generation system according to an embodiment.

FIG. 2 is a scheme showing an example of the osmotic pressure power generation method according to an embodiment.

FIG. 3 is schematic diagram showing an example of the osmotic pressure power generation system according to an embodiment.

FIG. 4 is schematic diagram showing an example of the osmotic pressure power generation system according to an embodiment.

FIG. 5 is a schematic diagram showing an example of the osmotic pressure power generation system according to an embodiment.

FIG. 6 is a schematic diagram showing an example of the osmotic pressure power generation system according to an embodiment.

FIG. 7 is a schematic diagram showing an example of the osmotic pressure power generation system according to an embodiment.

FIG. 8 is a schematic diagram showing an example of the osmotic pressure power generation system according to an embodiment.

FIG. 9 is a schematic diagram showing an example of the osmotic pressure power generation system according to an embodiment.

FIG. 10 is a schematic diagram showing an example of the osmotic pressure power generation system according to an embodiment.

FIG. 11 is a schematic diagram showing an example of a desalination system according to an embodiment.

FIG. 12 is a schematic diagram showing an example of the osmotic pressure generator according to an embodiment.

FIG. 13 is a schematic diagram showing an example of a desalination method according to an embodiment.

FIG. 14 is a schematic diagram showing an example of a desalination system according to an embodiment.

FIG. 15 is a schematic diagram showing an example of the desalination system according to an embodiment.

FIG. 16 is schematic diagram showing an example of a water treatment system according to an embodiment.

FIG. 17 is a schematic diagram showing an example of a water treatment method according to an embodiment.

FIG. 18 is schematic diagram showing an example of the water treatment system according to an embodiment.

FIG. 19 is diagram showing a syringe test device.

FIG. 20 is a diagram showing a syringe test device.

FIG. 21 is graph showing results of Examples 1 and 2.

FIG. 22 is graph showing results of Examples 3 and 4.

FIG. 23 is a graph showing results of Example 5.

FIG. 24 is a pattern diagram schematically showing an apparatus used in Example 6.

FIG. 25 is a graph showing results of Example 6.

FIG. 26 is a graph showing results of Example 6.

FIG. 27 is a graph showing results of Example 6.

FIG. 28 is a graph showing results of Example 6.

FIG. 29 is a graph showing results of Example 6.

FIG. 30 is an image diagram to calculate the height of water column from osmotic pressure.

FIG. 31 is a graph showing results of Example 7.

### DETAILED DESCRIPTION

As an embodiment of the water treatment method, a circulatory osmotic pressure power generation method will be explained below.

In general, according to one embodiment, a water treatment method uses a working medium which includes a water-containing solution to be treated and a draw solution. The draw solution is a hyperosmotic solution which generates an osmotic pressure difference with water. The method includes (1) generating a flux of a mixture of water and a draw solution by an osmotic pressure difference generated between a solution to be treated and the draw solution in an osmotic pressure generator compartmentalized by an osmosis membrane, (2) transferring the flux of the mixture to a vaporization-separation unit, (3) separating the mixture into the water and the draw solution by a pressure difference, and (4) recycling the draw solution separated by the vaporization-separation unit.

The circulatory osmotic pressure power generation method of the embodiment generates power by using a working medium including a hyperosmotic solution and water, the hyperosmotic solution generating an osmotic pressure difference with water. The method includes the steps of: in an osmotic pressure generator which includes a first chamber and a second chamber compartmentalized by an osmosis membrane, generating a flux of a mixture containing water and a hyperosmotic solution by an osmotic pressure difference generated between the water accommodated in the first chamber and the hyperosmotic solution accommodated in the second chamber; rotating a turbine by this flux of the mixture to generate power; in a vaporization-separation unit which includes a third chamber and a fourth chamber compartmentalized by a zeolite membrane, transferring the mixture after rotating the turbine to the third chamber; transferring water permeated through the zeolite membrane from the third chamber to the fourth chamber by a pressure difference between the fourth chamber and the third chamber to separate the water from the hyperosmotic solution; and transferring the obtained water to the first chamber and transferring the obtained hyperosmotic solution to the second chamber.

Such an embodiment can provide a circulatory osmotic pressure power generation system that is operable at low cost.

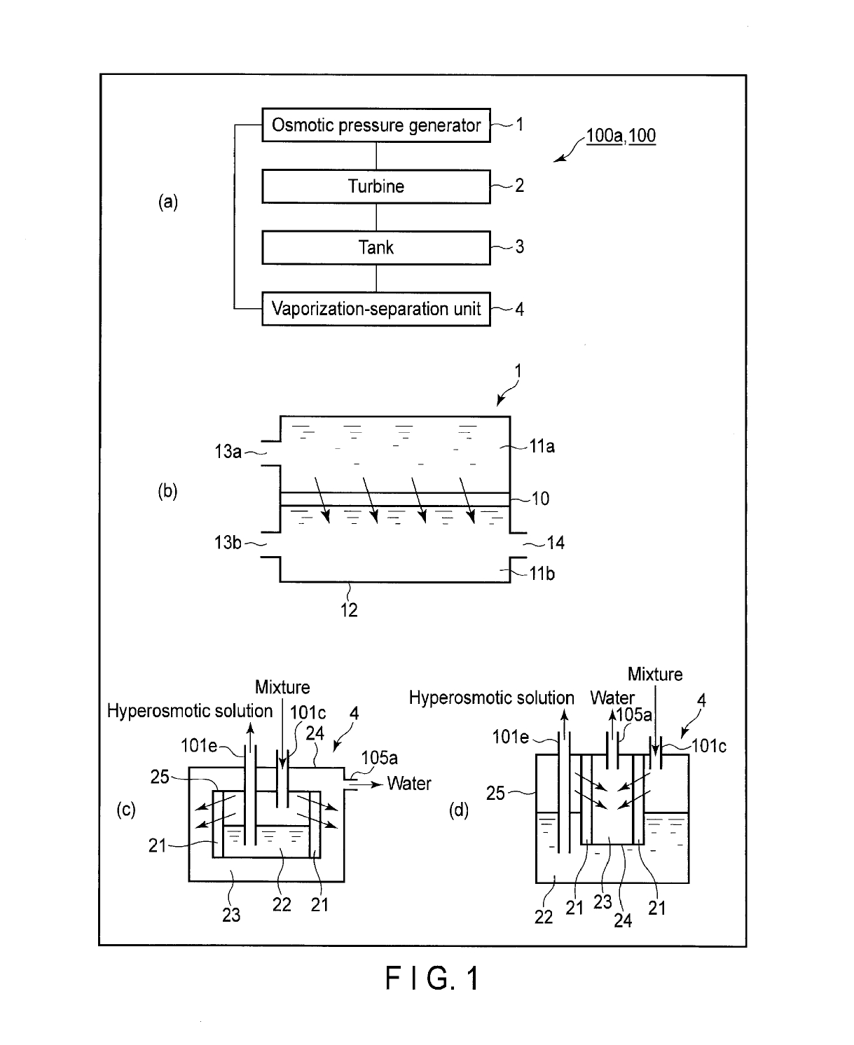

Hereinafter, embodiments will be explained with reference to the drawings. First, an example of the circulatory osmotic pressure power generation system will be described with reference to FIG. 1.

FIG. 1 (a) is a block diagram of the circulatory osmotic pressure power generation system. An osmotic pressure electric power generating apparatus 100a comprises an osmotic pressure generator 1, a turbine 2, a tank 3, and a vaporization-separation unit 4. The osmotic pressure generator 1, the turbine 2, the tank 3, and the vaporization-separation unit 4 are connected one another in this order to from a loop. A working medium circulates through the loop. In other words, the working medium circulates through the osmotic pressure generator 1, the turbine 2, the tank 3, and the vaporization-separation unit 4 in this order.

FIG. 1 (b) is a diagram schematically showing the example of the osmotic pressure generator 1. The osmotic pressure generator 1 comprises a treatment container 12 and first and second chambers 11a and 11b which are vertically formed by compartmentalizing the treatment container 12 by an osmosis membrane 10. The first and second chambers 11a and 11b are provided in the treatment container 12. The treatment container 12 is preferably airtight.

The working medium includes a hyperosmotic solution and water. The hyperosmotic solution may be a liquid having an osmotic pressure higher than that of water. Further, the hyperosmotic solution is compatible with water. The osmotic pressure of the hyperosmotic solution is higher than the osmotic pressure of water, and the difference in osmotic pressure between the hyperosmotic solution and water is used to generate power. In the osmotic pressure generator 1, water is accommodated in the first chamber 11a and the hyperosmotic solution is accommodated in the second chamber 11b.

An osmotic pressure difference is generated between water and the hyperosmotic solution which are arranged by sandwiching the osmosis membrane 10. The water flow is transferred from the first chamber 11a to the second chamber 11b by the osmotic pressure difference. The water flow generates a flux. The turbine 2 is rotated twice by the flux transferred thereto, thereby generating power. The liquid forming a flux is a mixture. The mixture includes the water flowing out from the first chamber into the second chamber 11b through the osmosis membrane 10 and the hyperosmotic solution accommodated in the second chamber 11b. After rotating the turbine 2, the mixture is transferred to the vaporization-separation unit 4. The vaporization-separation unit 4 separates the liquid into water and a hyperosmotic solution. Thus, the hyperosmotic solution and water are regenerated. The regenerated water and hyperosmotic solution are transferred to the chambers of the osmotic pressure generator 1 and recycled for power generation.

As shown in a pattern diagram of FIG. 1 (c), the vaporization-separation unit 4 includes a housing 24 and a separation part 25 which is formed of, for example, a pressure resistant airtight container and is disposed in the housing 24. A side wall of the separation part 25 is formed of a zeolite membrane 21. The zeolite membrane 21 compartmentalizes the chamber into a third chamber 22 at the separation part 25 side and a fourth chamber 23 at the housing 24 side. After rotating the turbine 2, the mixture is transferred to the third chamber 22 of the vaporization-separation unit 4 through a pipeline 101c to be described below. Here, the third chamber 22 is a chamber at the side to which the mixture to be separated is supplied (at the first side of the zeolite membrane). The fourth chamber 23 is a chamber at the side in which the water separated from the mixture through the zeolite membrane 21 is received (at the second side of the zeolite membrane or the permeation side). Basically, the pressure of the fourth chamber 23 is lower than the pressure of the third chamber 22 in the vaporization-separation unit 4. For example, the pressure in the fourth chamber 23 is reduced. Thus, the water in the mixture in the third chamber 22 permeates the zeolite membrane 21 and moves to the fourth chamber 23, thereby being separated. In other words, the water moves from the third chamber 22 to the fourth chamber 23 by a pressure difference between the inside of the third chamber 22 and the inside of the fourth chamber 23. In the fourth chamber 23, the water in the form of gas is converted to a liquid in the recovery step. The water permeated through the zeolite membrane 21 is recovered and again transferred to the osmotic pressure generator 1 via a pipeline 105a to be described below, to use for power generation. On the other hand, the dehydrated hyperosmotic solution is transferred to the osmotic pressure generator 1 via a pipeline 101e to be described below and used for power generation.

Here, as for a positional relationship between the third chamber and the fourth chamber in the vaporization-separation unit 4, either of them may be located inside or outside. FIG. 1 (c) shows an example in which the third chamber 22 is disposed inside the fourth chamber 23 and FIG. 1 (d) shows an example in which the third chamber 22 is disposed outside the fourth chamber 23. Further, the vaporization-separation unit 4 comprises a plurality of zeolite membranes, and thus may comprise a plurality of supply and permeation sides. A zeolite membrane may be lined with a hollow cylindrical ceramic support. In that case, the ceramic support does not impair the function of the zeolite membrane.

The obtained water is transferred to the osmotic pressure generator 1 and accommodated in the first chamber 11a. On the other hand, the obtained hyperosmotic solution is transferred to the osmotic pressure generator 1 and accommodated in the second chamber 11b. The osmotic pressure generator 1 generates a flux by an osmotic pressure difference generated between the water in the first chamber 11a and the hyperosmotic solution in the second chamber 11b. Power generation, separation, solution transfer are performed in the same manner as described above. Thus, the working medium circulates inside the osmotic pressure electric power generating apparatus 100a. As a result, the osmotic pressure power generation system continuously generates power.

Separation of the water and hyperosmotic solution in the vaporization-separation unit 4 may be performed in such a manner that an osmotic pressure difference generated between the water and the hyperosmotic pressure is generated when allowing to flow into the osmotic pressure generator 1 after the separation. The water obtained in the vaporization-separation unit 4 is high purity water. However, the hyperosmotic solution separated from water in the vaporization-separation unit 4 may contain water at arbitrary concentration. The water contained at arbitrary concentration may indicate a concentration such that when the water and hyperosmotic solution are again accommodated in the osmotic pressure generator 1, an osmotic pressure difference is generated between the hyperosmotic solution and water.

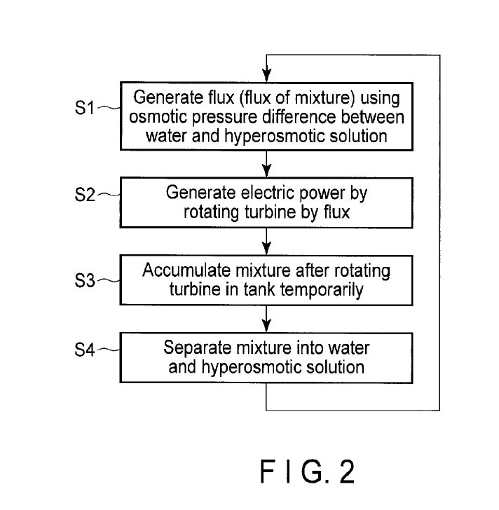

Power generation in the circulatory osmotic pressure power generation system will be described with reference to FIG. 2. First, the osmotic pressure generator 1 generates a flux by the osmotic pressure difference generated between the water and the hyperosmotic solution (S1).

Next, the flux generated in S1 rotates the turbine, thereby generating power (S2). Here, the flux is generated by a mixture containing the water and the hyperosmotic solution. The tank temporarily accommodates the mixture which generates the flux after rotating the turbine (S3). Then, the mixture contained in the tank is transferred to the vaporization-separation unit 4 and separated into water and a hyperosmotic solution (S4). The water and hyperosmotic solution separated in S4 are again transferred to the osmotic pressure generator 1. Thereafter, the osmotic pressure generator 1 again generates a flux by the osmotic pressure difference in the same manner as described above (S1). The circulatory osmotic pressure power generation system can continuously generate power by repeating this step. Hence, circulatory power generation is performed.

In the conventional osmosis power generation using ammonium carbonate, the inside of the system is deteriorated by generation of toxic and corrosive ammonia gas, which leads to a considerable impact on operation cost. According to the embodiment, it is possible to provide a working medium which does not generate the ammonia gas (draw solution), a circulatory osmotic pressure power generation method using the same, and a circulatory osmotic pressure power generation system. According to the circulatory osmotic pressure power generation system of the embodiment, it is possible to use a common organic solvent as the working medium.

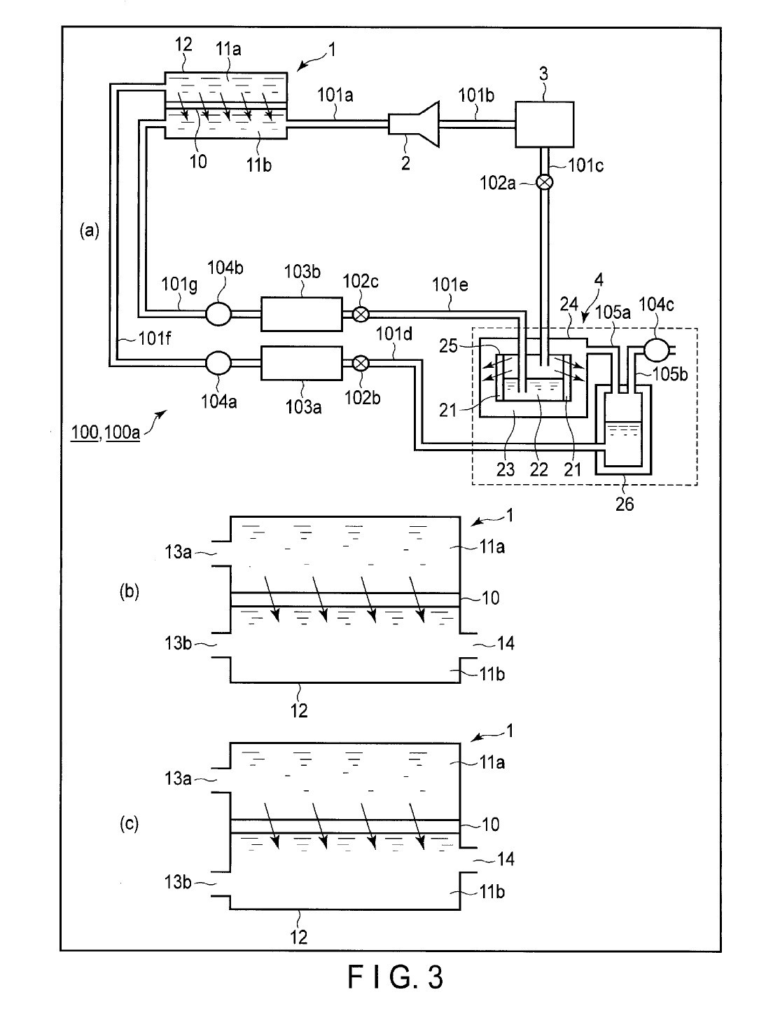

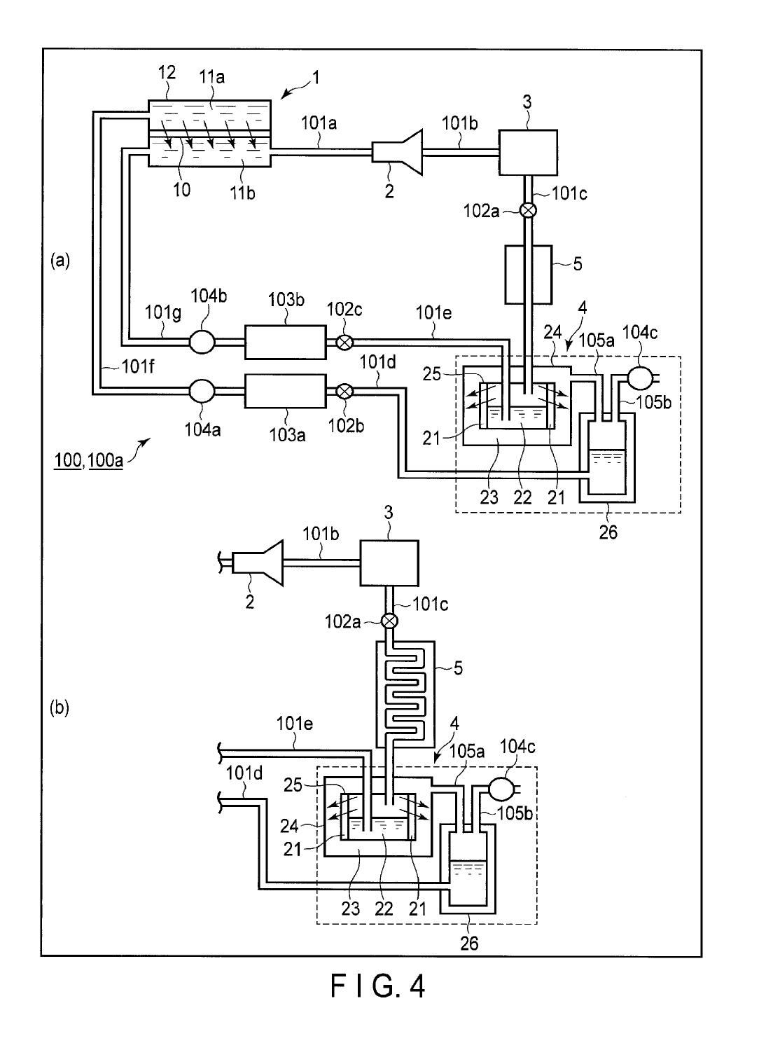

Examples of the circulatory osmotic pressure power generation system according to the embodiments will be described with reference to FIGS. 3 to 10. In this regard, in the circulatory osmotic pressure power generation system shown in FIGS. 4 to 10, the same reference numerals denote the same members as those in FIG. 3 and the description is omitted.

### (1) First Embodiment

FIG. 3 (a) is a schematic diagram of an example of the circulatory osmotic pressure power generation system.

The circulatory osmotic pressure power generation system 100 comprises an osmotic pressure electric power generating apparatus 100a and a working medium which circulates inside the osmotic pressure electric power generating apparatus 100a. The osmotic pressure electric power generating apparatus 100a comprises an osmotic pressure generator 1, a turbine 2, a buffer tank 3, a vaporization-separation unit 4, a water tank 103a, and a hyperosmotic solution tank 103b. The osmotic pressure generator 1 and the turbine 2 are connected to each other via a pipeline 101a. The turbine 2 and the buffer tank 3 are connected to each other via a pipeline 101b. The buffer tank 3 and the vaporization-separation unit 4 are connected to each other via a pipeline 101c. An on-off valve 102a is interposed in the pipeline 101c. The vaporization-separation unit 4 and the water tank 103a are connected to each other via a pipeline 101d. An on-off valve 102b is interposed in the pipeline 101d. The vaporization-separation unit 4 and the hyperosmotic solution tank 103b are connected to each other via a pipeline 101e. An on-off valve 102c is interposed in the pipeline 101e. The water tank 103a and the osmotic pressure generator 1 are connected to each other via a pipeline 101f. A pump 104a is interposed in the pipeline 101f. The hyperosmotic solution tank 103b and the osmotic pressure generator 1 are connected to each other via a pipeline 101g. A pump 104b is interposed in the pipeline 101g.

Here, the internal structure of the osmotic pressure generator 1 will be further described with reference to the cross-sectional diagram of FIG. 3 (b). The osmotic pressure generator 1 comprises a treatment container 12 and an osmosis membrane 10. The osmosis membrane 10 is placed in the treatment container 12 while the periphery of the membrane being fixed onto inner wall surfaces of the treatment container 12, thereby compartmentalizing the inside of the treatment container 12 into the first chamber 11a and the second chamber 11b. In the treatment container 12, the first chamber 11a is arranged above the second chamber 11b. The treatment container 12, in which the first chamber 11a is located, has an opening of a first inlet 13a. Water separated by the vaporization-separation unit 4 flows in the first inlet 13a. The treatment container 12, in which the second chamber 11b is located, has an opening of a second inlet 13b. A hyperosmotic solution separated by the vaporization-separation unit 4 flows in the second inlet 13b. The treatment container 12, in which the second chamber 11b is located, has an opening of an outlet 14. The outlet 14 is placed on a wall surface facing the wall surface having an opening of the second inlet 13b. The direction in which the liquid (water) permeates the osmosis membrane 10 is an upper-to-lower direction as indicated by arrows, namely a direction from the first chamber 11a to the second chamber 11b. Here, openings of the inlet 13b and the outlet 14 are formed on mutually facing wall surfaces of the treatment container 12, and the positions in the wall surfaces may be optionally selected. For example, as shown in FIG. 3 (b), the inlet 13b and the outlet 14 may be located so as to face to each other.

Alternatively, as shown in FIG. 3 (c), one of them is opened closer to the osmosis membrane 10, and the other may be opened in a position away from the osmosis membrane 10. Further, the outlet 14 may be opened in a surface facing the osmosis membrane 10 in the treatment container 12.

The outlet 14 is connected to the pipeline 101a. A mixture of water flowed out from the first chamber 11a into the second chamber 11b through the osmosis membrane 10 and a hyperosmotic solution accommodated in the second chamber 11b flows out from the outlet 14. As the water permeates the osmosis membrane 10 and moves from the first chamber 11a to the second chamber 11b, the water pressure in the second chamber 11b increases, thereby creating a liquid flow from the outlet 14. That is, a flux is generated. The generated flux rotates the turbine 2, thereby generating power.

The vaporization-separation unit 4 comprises a housing 24, a separation part 25, a water trap 26, and a vacuum pump, a pipeline 105a which connects the housing 24 to the water trap 26, and a pipeline 105b which is extended from the water trap 26 to outside. The housing 24 may be a pressure resistant airtight container. The housing 24 comprises a separation part 25 therein. The separation part 25 is formed of, for example, a pressure resistant airtight container. A wall surface by which a space in the separation part 25 is determined is formed of a zeolite membrane. The inside and outside of the separation part 25 is separated by the zeolite membrane. Further, the zeolite membrane 21 has liquid tightness when there is no pressure difference between the inside and outside thereof. On the other hand, the zeolite membrane 21 has a water permeation property when the pressure difference exists. As shown in FIG. 3 (a), the third chamber 22 is a space in the separation part 25 which is determined by the zeolite membrane 21. The fourth chamber 23 is a space which is determined by the zeolite membrane 21 and the housing 24.

The lower end of the pipeline 101c leading from the buffer tank 3 is passed through an upper opening (not shown) of the housing 24 and an upper opening (not shown) of the separation part 25 and extended to reach inside of the separation part 25. The on-off valve 102a interposed in the pipeline 101c is opened to transfer the mixture accommodated in the buffer tank 3 to the separation part 25 via the pipeline 101c. One end (right end) of the pipeline 101e is passed through an upper opening (not shown) of the housing 24 and an upper opening (not shown) of the separation part 25 and extended to reach inside of the separation part 25. The other end (left end) thereof is connected to the hyperosmotic solution tank 103b. After separation of the water and the hyperosmotic solution in the vaporization-separation unit 4, the on-off valve 102c interposed in the pipeline 101e is opened. The on-off valve 102c is opened to transfer the separated hyperosmotic solution remaining in the separation part 25 to the hyperosmotic solution tank 103b via the pipeline 101e.

The water trap 26 is a pressure resistant airtight container. The pipeline 105a leading from the housing 24 is connected to an upper opening of the water trap 26. Another opening is provided in the top of the water trap 26 and the pipeline 105b is extended from the opening to outside. A vacuum pump 104c is interposed in the pipeline 105b. When the vacuum pump 104c is operated, the gas in the fourth chamber 23 is sucked via the pipeline 105b, the water trap 26 and the pipeline 105a, and the inside of the fourth chamber 23 is converted to negative pressure. Consequently, a portion of the mixture included in the third chamber 22 is evaporated. The evaporated water permeates the zeolite membrane 21 and moves to the fourth chamber 23.

The on-off valves 102a, 102b, and 102c are closed to perform separation in the vaporization-separation unit 4. After that, the vacuum pump 104c is operated to reduce the pressure in the water trap 26 and the fourth chamber 23. Hence, the pressure in the fourth chamber 23 is reduced. Thus, moisture content permeates the zeolite membrane 21 and moves from the third chamber which is located inside of the separation part 25 to the fourth chamber. The water moved to the fourth chamber is introduced into the water trap 26 via the pipeline 105a and accumulated as a liquid. Thus, a pressure difference is provided between the inside of the fourth chamber and the inside of the third chamber, whereby the water is transferred from the third chamber to the fourth chamber. Thus, it is possible separate the mixture into water and a hyperosmotic solution.

Separation in the vaporization-separation unit 4 is performed by a pervaporation method. For example, a pervaporation membrane used in the method is preferably a zeolite membrane. The zeolite membrane for performing the pervaporation method may be any commercially available product. For example, MSM-1, manufactured by Mitsubishi Chemical Corporation, can be used as the zeolite membrane. As the vaporization-separation unit 4, a commercially available water separation device which uses the pervaporation method may be used. In a commercially available common water separation device which uses the pervaporation method, a mixture to be dehydrated is heated before the mixture is accommodated in a ceramic tube having a zeolite membrane. In the pervaporation method, when the mixture is evaporated by reduced pressure, the temperature of the mixture is decreased. As the temperature increases, evaporation of the mixture is promoted, leading to water separation. Examples of the process of heating the mixture will be described later. It is more preferable that exhaust heat is used to heat the mixture. As a result, a high gain can be obtained. In the method and apparatus which use the pervaporation method, well-known techniques may be used. Such techniques are described in, for example, Jpn. Pat. Appln. KOKAI Publication Nos. 7-31851, 7-80252, 7-194942, and 11-276801.

The zeolite membrane may be, for example, a chabazite-type zeolite. It is said that the zeolite membrane has 200 or more crystal forms. Among them, it is preferable to use a chabazite-type crystal form. In the zeolite membranes, a zeolite A type is known as the crystal form which permeates water but does not permeate any molecule larger than water. However, when the amount of water in an aqueous solution is high, the zeolite A type easily dissolves and is also vulnerable to acid. On the other hand, a chabazite-type zeolite membrane does not decompose even if the amount of water is high, and has high resistance to acids.

The osmosis membrane 10 used in the osmotic pressure generator 1 may be any commercially available one as long as it is not damaged by a liquid used as the working medium, for example, an organic solvent. Usable examples of the osmosis membrane 10 include a cellulose acetate film and a polyamide film. The osmosis membrane 10 may be a forward osmosis membrane or a reverse osmosis membrane. As the osmosis membrane 10, the forward osmosis membrane is preferred. The treatment container 12 may be formed of a material suitable to accommodate the working medium. The treatment container 12 may be a container having airtightness, i.e., a sealed treatment container.

As the osmosis membrane 10, a polymer hollow filament may be used to enlarge a membrane area.

As described above, the working medium includes a hyperosmotic solution and water. The hyperosmotic solution may be a hyperosmotic solution that generates a difference in osmotic pressure with water. Generally, the working medium is known as the draw solution.

When the hyperosmotic solution includes a solvent and a solute which dissolves in the solvent, a substance in which an osmotic pressure difference is generated between the hyperosmotic solution and water may be selected as the solute. In this case, the solvent may be water or an organic solvent.

Generally, the working medium of the embodiment is a two-component mixed solution which contains water and a hyperosmotic solution. When the hyperosmotic solution and the water are disposed side by side through the osmosis membrane, an osmotic pressure difference is generated between the hyperosmotic solution and water. As a result, the water drawn by the hyperosmotic solution permeates the osmosis membrane and moves to the side of the hyperosmotic solution. Here, the wording “the hyperosmotic solution and the water are disposed side by side through the osmosis membrane” means a state in which the hyperosmotic solution is brought into contact with one surface of the osmosis membrane and the water is brought into contact with the other surface. The working medium rotates the turbine 2 depending on the osmotic pressure difference, thereby generating power.

In the case of using such a working medium in the circulatory osmotic pressure power generation system of FIG. 1, the working medium is in a state of being separated into water and a hyperosmotic solution until immediately before being transferred to the first chamber and the second chamber in the osmotic pressure generator 1. In the osmotic pressure generator 1, the water always moves to the inside of the hyperosmotic solution near the osmosis membrane of the second chamber. At this time, the hyperosmotic solution and the water flowing therein are mutually dissolved with each other. The mixture of the hyperosmotic solution and the water rotates the turbine 2, passes through the buffer tank 3, and is separated in the vaporization-separation unit 4.

For example, the hyperosmotic solution may be polyalcohol or an aqueous polyalcohol solution. The polyalcohol is preferably a compound represented by Formula 1 below.

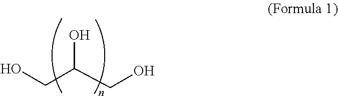

Here, n represents an integer of 0 or more, preferably an integer of 1 or more, and more preferably an integer of 3 or more. For example, n may represent an integer of 1 to 5, an integer of 1 to 4, an integer of 1 to 3 or an integer of 1 to 6. For example, it is preferable that n represents an integer of 3 to 5.

When n represents 0, 1 or 3, the compound of Formula 1 is ethylene glycol, glycerin or xylitol. When n represents 4, the compound of Formula 1 is sorbitol or mannitol. When n represents 5, the compound of Formula 1 is perseitol or volemitol. When n represents 6, the compound of Formula 1 is, for example, D-erythro-D-galacto-octitol. However, the hyperosmotic solution according to the embodiment is not limited thereto.

The water and hyperosmotic solution separated in the vaporization-separation unit 4 are transferred to the first chamber 11a and the second chamber 11b in the osmotic pressure generator 1. In the osmotic pressure generator 1, a flux is generated by the osmotic pressure difference generated between the transferred water and hyperosmotic solution. This flux transferred to the turbine 2 operates the turbine 2 (or rotates), thereby generating power. After operating the turbine 2, the liquid is transferred to the tank 3 and then transferred to the vaporization-separation unit 4. In the vaporization-separation unit 4, the liquid is separated into water and a hyperosmotic solution using the above-described operation and mechanism. Thus, the working medium is regenerated. The separated water and hyperosmotic solution are transferred to the osmotic pressure generator 1. The system can continuously generate power by repeating such a cycle. In the circulation, the buffer tank 3, the water tank 103a, and the hyperosmotic solution tank 103b are disposed in order to perform separation in the vaporization-separation unit 4 quickly. After operating the turbine 2, the mixture is once accommodated in the buffer tank 3. Therefore, the separation step in the vaporization-separation unit 4 can be normally performed in parallel with the operation of the turbine 2 by the osmotic pressure generator 1 and power generation. The water and the hyperosmotic solution after separation are once accommodated in the water tank 103a and the hyperosmotic solution tank 103b, respectively, so as not to prevent the separation step.

The circulatory osmotic pressure power generation method based on the circulatory osmotic pressure power generation system generates power using a hyperosmotic solution that generates an osmotic pressure difference with water and a working medium contained water. The method includes the steps of: in an osmotic pressure generator which includes a first chamber and a second chamber compartmentalized by an osmosis membrane, generating a flux of a mixture containing water and a hyperosmotic solution by an osmotic pressure difference generated between the water accommodated in the first chamber and the hyperosmotic solution accommodated in the second chamber; rotating a turbine by this flux to generate power; transferring the mixture after rotating the turbine to a third chamber in a vaporization-separation unit which includes a third chamber and a fourth chamber compartmentalized by a zeolite membrane; transferring water permeated through the zeolite membrane from the third chamber to the fourth chamber by a pressure difference between the fourth chamber and the third chamber to separate into the water and the hyperosmotic solution; and transferring the obtained water to the first chamber and transferring the obtained hyperosmotic solution to the second chamber.

Such a circulatory osmotic pressure power generation system may be operated as follows. First, water is accommodated in the first chamber 11a of the osmotic pressure generator 1 and then a hyperosmotic solution is accommodated in the second chamber 11b. Thereafter, a flux is generated by the osmotic pressure difference in the osmotic pressure generator 1. The flux is transferred from the outlet 14 to the turbine 2 via the pipeline 101a. The flux of the mixture rotates the turbine 2, thereby generating power.

After rotating the turbine 2 to generate power, the mixture is transferred to the buffer tank 3 through the pipeline 101b. The buffer tank 3 temporarily accommodates the mixture. The buffer tank 3 is connected to the vaporization-separation unit 4 via the pipeline 101c. The on-off valve 102a is interposed in the pipeline 101c. The on-off valve 102a is closed when the phase separation of the working medium is in progress in the vaporization-separation unit 4 and the liquid is transferred from the vaporization-separation unit 4. In order to introduce the mixture into the vaporization-separation unit 4, the on-off valve 102a is opened.

The vaporization-separation unit 4 includes an inlet through which the mixture in the buffer tank 3 flows in and two outlets through which the separated water and hyperosmotic solution flow out. The on-off valves 102a, 102b, and 102c are closed while the mixture is separated in the vaporization-separation unit 4, thereby promoting separation.

After the separation of the mixture is finished in the vaporization-separation unit 4, the water and the hyperosmotic solution are transferred from the vaporization-separation unit 4 to the pipeline 101d and the pipeline 101e, respectively. Thereafter, the on-off valves 102b and 102c are closed.

After closing the on-off valves 102b and 102c, the on-off valve 102a is opened to allow the mixture accommodated in the buffer tank 3 to flow into the vaporization-separation unit 4. A sufficient amount of the mixture flows into the vaporization-separation unit 4, and then the on-off valve 102a is closed. The above-described separation operation in the vaporization-separation unit 4 is repeated to generate power by circulating the mixture.

Two liquids flowing out from the vaporization-separation unit 4 are passed through the pipeline 101d and the pipeline 101e, respectively, and temporarily accommodated in the water tank 103a and the hyperosmotic solution tank 103b, respectively. The two liquids in the water tank 103a and in the hyperosmotic solution tank 103b are transferred to the osmotic pressure generator 1 through the pipelines 101f and 101g, respectively, by operating the pumps 104a and 104b, if necessary.

In other words, the hyperosmotic solution is transferred and temporarily accommodated in the tank 103a by opening the on-off valve 102b. The water is transferred and temporarily accommodated in the tank 103b by opening the on-off valve 102c. At this point of time, the working medium is already regenerated in a reused state. Thereafter, the hyperosmotic solution accommodated in the tank 103a is transferred to the first chamber 11a of the osmotic pressure generator 1 through the pipeline 101d by operating the pump 104a. The water contained in the tank 103b is transferred to the second chamber 11b of the osmotic pressure generator 1 through the pipeline 101e by operating the pump 104b.

By the circulation of the working medium in the osmotic pressure electric power generating apparatus 100a, the circulatory osmotic pressure power generation system continuously generates power. The power generation system simplifies the separation operation and the transfer of the liquid after separation. Further, it is possible to recover high purity water by separation. As a result, it is possible to efficiently generate a flux in the osmotic pressure generator 1.

Further, the operation cost can be reduced. Further, the working medium does not produce gas, and therefore the structure of the vaporization-separation unit 4 can be simplified. Any component which damages the osmotic pressure electric power generating apparatus 100a, such as ammonia gas, is not generated, thereby reducing labor for maintenance of the apparatus, compared to the conventional apparatus. Thus, the maintenance cost can also be decreased, and further the construction and plant operation costs are reduced. As described above, the embodiment can provide a circulatory osmotic pressure power generation system that is operable at low cost.

The embodiment is different from the case of generating power through osmotic pressure using river water and sea water, and it is possible to generate power through osmotic pressure using the liquid shut off from the outside. As a result, the osmosis membrane in the osmotic pressure generator is not exposed to biotic contamination and it is possible to prolong the lifetime of the membrane, thereby reducing the cost.

Labor for maintenance during the process such as back washing (process of cleaning water by allowing it to flow in a reverse direction) as well as the cost can be significantly reduced, thereby prolonging the operation time and increasing the operation rate. Since ammonia gas is not used as the working medium, it is not necessary to use a multi-staged distillation system, thereby simplifying the system design.

After separation between liquid phases, the liquid can be recovered directly from each of the liquid phases via a pipeline and the recovered liquid can be recycled.

As the working medium, an optimal substance can be selected from substances having similar properties. Accordingly, the degree of freedom in system design is improved. Although ammonia is corrosive and toxic, safe one can be selected by phase control and the range of selection thereof can be expanded in the embodiment. Further, the working medium circulating in the system does not produce gas at any portion, step, or even in the separating step, and therefore it is even safer.

### (2) Second Embodiment

As described above, the operation of separating water using the zeolite membrane can be facilitated by increasing the temperature of the mixture. For example, as shown in FIG. 4 (a), it is preferable that a heat source 5 is interposed in a pipeline 101c which transfers the mixture to a separation part 25. Thus, it is possible to separate water from the mixture more smoothly or efficiently. Hence, the degree of reduced pressure in a fourth chamber in a vaporization-separation unit can be decreased. Even if the pressure difference between a third chamber and the fourth chamber is small, the water is separated.

The heat source 5 is preferably a publicly known heat exchanger. For example, it is preferable that heating is performed by a heat exchanger using heat exhaust heat of a factory, an electricity generating plant, a public facility, and a house, ground heat, natural energy (e.g., sunlight energy) or the like. The heat source 5 may be any heat source as long as it has a structure which applies heat to the mixture flowing through the pipeline 101c. The circulatory osmotic pressure power generation system shown in FIG. 4 (a) has the same structure as that of the system shown in FIG. 3 (a) except that it comprises the heat source 5. Therefore, it is possible to generate power in the same manner as in the example shown in FIG. 3.

In order to apply heat from the heat source 5 to the pipeline 101c more efficiently, the pipeline 101c corresponding to the position of the heat source 5 may be bent in a zigzag pattern. FIG. 4 (b) shows an example in which a part of the pipeline 101c is bent in a zigzag pattern. The number of times of bending of the zigzag pattern part may be optionally changed. In order to increase the surface area of the pipeline 101c which receives heat from the heat source 5, it is preferable to adopt a strategy except for the process of bending the pipeline 101c into a zigzag pattern. In this case, it is possible to generate power in the same manner as in the example shown in FIG. 3 (a).

### (3) Third Embodiment

The circulatory osmotic pressure power generation system 100 shown in FIG. 3 or FIG. 4 may further comprise a pressure exchanger or a pumping-up device.

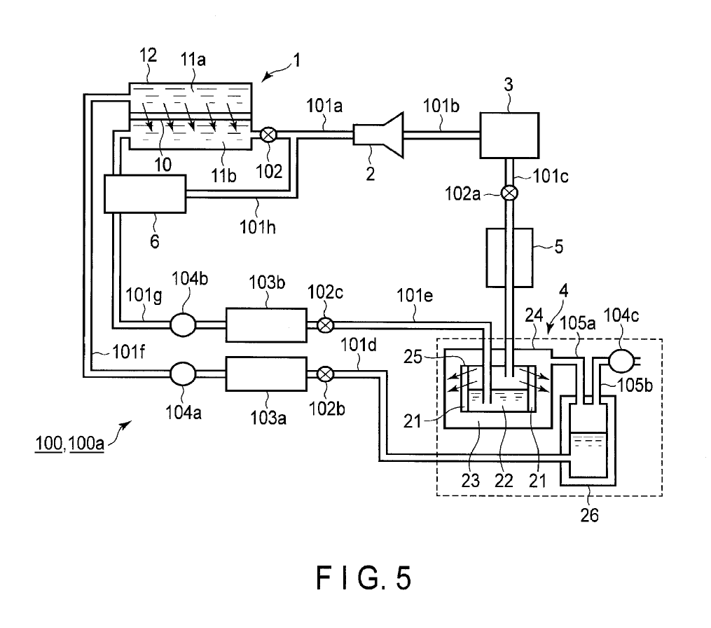

FIG. 5 shows an example in which the circulatory osmotic pressure power generation system 100 comprises a pressure exchanger 6. The pressure exchanger 6 is interposed and bridged over between a pipeline 101g and a pipeline 101a in order to exchange the pressure the pipelines 101a and 101g via a pipeline 101h as a bypass. The flux of the liquid which rotates a turbine 2, depends not only the osmotic pressure difference generated between the water in a first chamber 11a and the hyperosmotic solution in the second chamber 11b, but also on the difference in liquid pressure between the hyperosmotic solution flowing into the second chamber 11b through the second inlet 13b after passing through the pipeline 101g and the water flowing into the first chamber 11a through the first inlet 13a after passing through the pipeline 101f. Therefore, it is preferable that the liquid pressure in the pipeline 101g is adjusted between the pipeline 101g and the pipeline 101a which is connected via the pipeline 101h as a bypass using the pressure exchanger 6. In other words, the difference in liquid pressure between the hyperosmotic solution regenerated in the vaporization-separation unit 4 flowing again into the osmotic pressure generator 1 and water is adjusted. As a result, the electric energy obtained by power generation can be maximized. The pressure exchanger 6 for adjusting the difference in liquid pressure between the water flowing into the first chamber 11a through the first inlet 13a and the hyperosmotic solution flowing into the second chamber 11b may be interposed and bridged between any pipelines in order to obtain a desired difference in liquid pressure.

Further, the circulatory osmotic pressure power generation system 100 may further comprise a pumping-up device (not shown). When the circulatory osmotic pressure power generation system 100 further comprises the pumping-up device, the pumping-up device may be interposed in the pipeline 101a between the osmotic pressure generator 1 and the turbine 2. The pumping-up device is formed in the osmotic pressure electric power generating apparatus 100a, whereby the working medium can be circulated more easily. As a result, the power generation by the turbine 2 can be more reliably carried out. The pumping-up device moves and accommodates the liquid from the osmotic pressure generator 1 to a level higher than the positions where the osmotic pressure generator 1 and the turbine 2 are disposed. Then, the liquid is dropped towards the turbine 2 from the high level at a predetermined flow, and thus the turbine 2 is rotated by the descending flux.

### (4) Fourth Embodiment

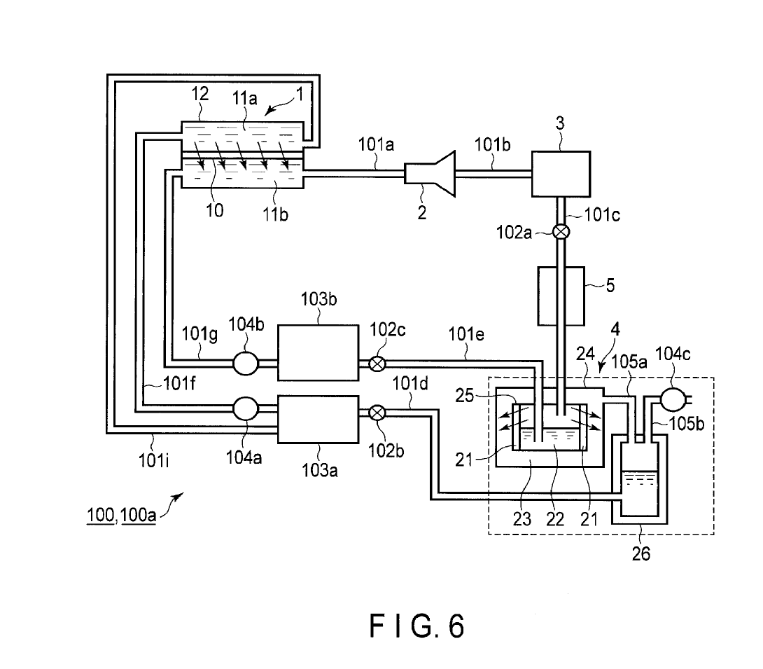

The circulatory osmotic pressure power generation system 100 may further comprise a pipeline 101i which connects a first chamber 11a to a water tank 103a. FIG. 6 shows an example of the embodiment. The circulatory osmotic pressure power generation system 100 shown in FIG. 6 is an example in which the circulatory osmotic pressure power generation system 100 shown in FIG. 4 comprises a pipeline 101i which connects the first chamber 11a to the water tank 103a. The circulatory osmotic pressure power generation system 100 has the same as the circulatory osmotic pressure power generation system 100 shown in FIG. 4 except for the above structure. Alternatively, the circulatory osmotic pressure power generation system 100 of another embodiment may comprise the pipeline 101i. Further, the circulatory osmotic pressure power generation system 100 may comprise an on-off valve (not shown) interposed in the pipeline 101i.

In the circulatory osmotic pressure power generation system 100 shown in FIG. 6, an outlet is provided in a treatment container 12 located in the first chamber 11a of the osmotic pressure generator 1 and the water tank 103a has another inlet. The outlet of the first chamber 11a is connected to the inlet of the water tank 103a via the pipeline 101i. Thus, a portion of the liquid not flowing out from the first chamber 11a into a second chamber 11b is returned to the water tank 103a by passing through the outlet of the first chamber 11a via the pipeline 101i. As a result, the water quality in the first chamber 11a can be kept constant, or fresh water can be always used. Accordingly, it is possible to prevent the inside of the first chamber 11a from being contaminated and rusted.

Further, an on-off valve interposed in the pipeline 101i allows the water to flow out from the outlet of the first chamber 11a or shuts off the flow of the water.

### (5) Fifth Embodiment

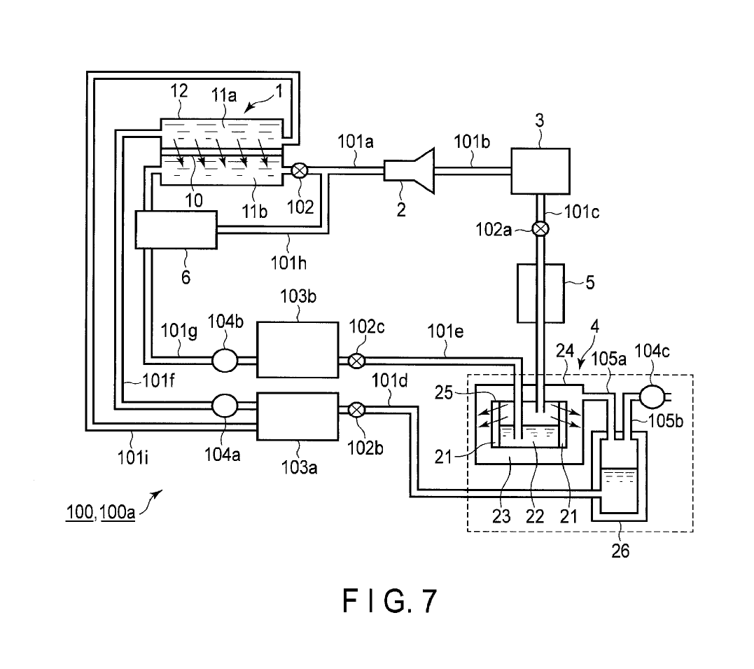

FIG. 7 shows an example in which the circulatory osmotic pressure power generation system 100 according to another embodiment comprises a pressure exchanger 6 and a pipeline 101i. It has the same structure as any of the structures of the circulatory osmotic pressure power generation system 100, except that it comprises the above members, and it can be operated in the same manner as in any of the combined operational processes.

### (6) Sixth Embodiment

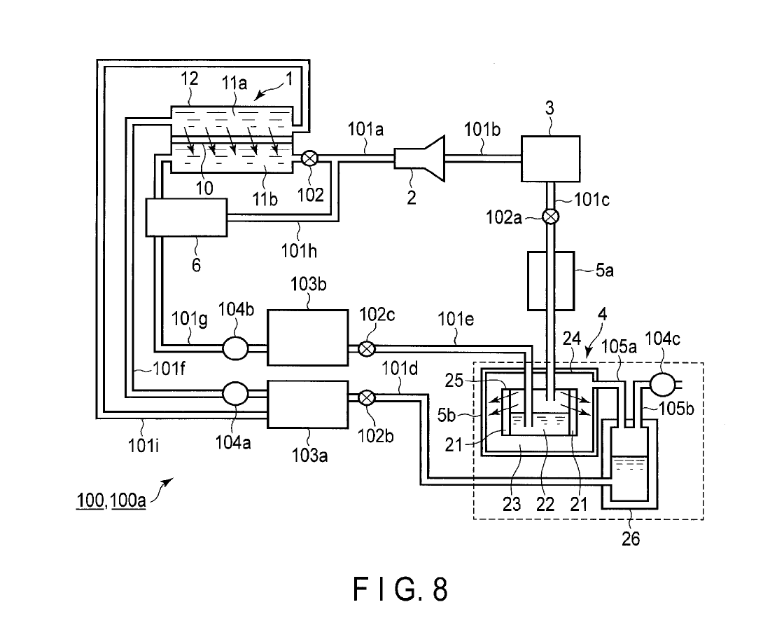

FIG. 8 shows an example in which any of the above-described circulatory osmotic pressure power generation systems 100 comprises two heat sources, i.e., heat sources 5a and 5b. As shown in FIG. 8, the circulatory osmotic pressure power generation system 100 comprises a heat source 5a which is interposed in a pipeline 101c and a heat source 5b which is disposed outside of a housing 24 and applies heat to the housing 24. The two heat sources are included so that it is possible to perform separation more smoothly or efficiently. The heat source 5b may be the same as that of the heat source 5.

### (7) Seventh Embodiment

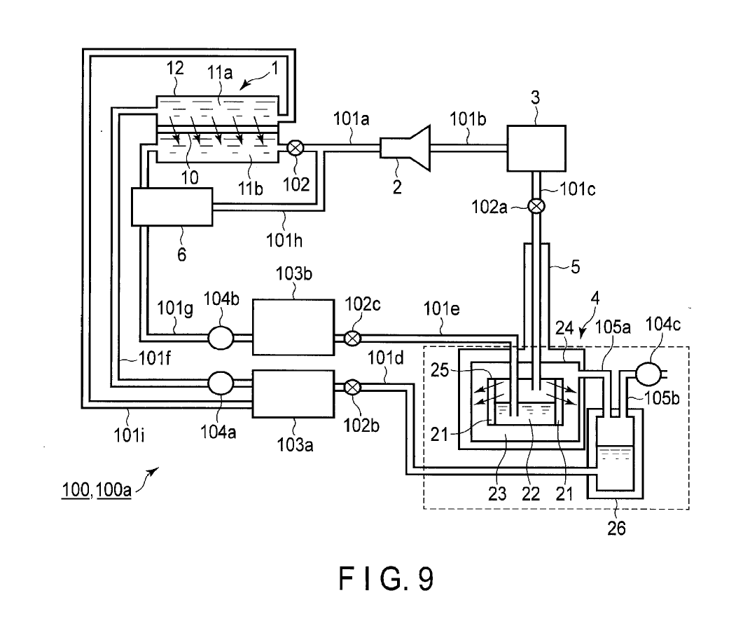

In FIG. 9, a heat source 5 which applies heat to the area from the section near midway of a pipeline 101c to a housing 24 of a vaporization-separation unit 4. The circulatory osmotic pressure power generation system 100 may have the same structure as any of those of the embodiments except for the structure of the heat source 5. According to such a structure, it is possible to perform separation more smoothly or efficiently.

### (8) Eighth Embodiment

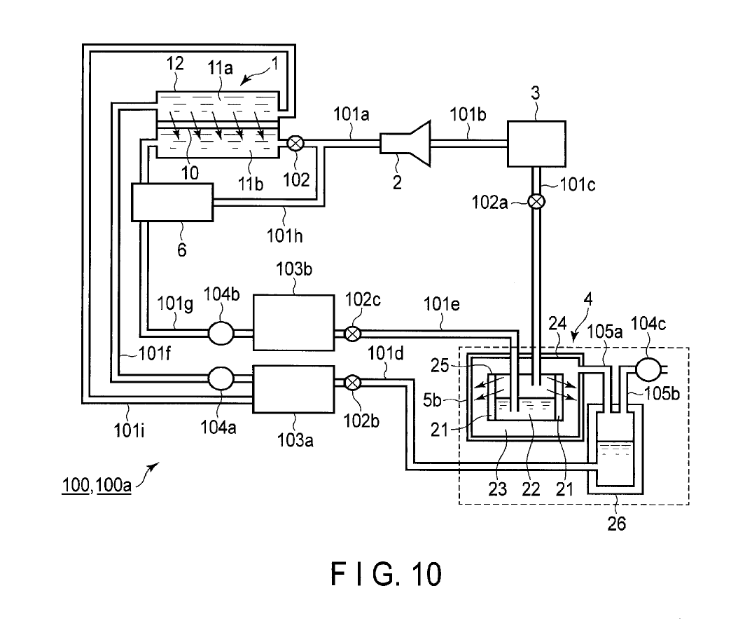

FIG. 10 shows an example in which the circulatory osmotic pressure power generation system 100 shown in FIG. 8 comprises a heat source 5b which applies heat to a mixture contained in a housing 24 of a vaporization-separation unit 4. The circulatory osmotic pressure power generation system 100 may have the same structure as that of the embodiment except for the heat source 5b. According to such a structure, it is possible to perform separation more smoothly or efficiently.

The examples of the circulatory osmotic pressure power generation system 100 have been described with reference to FIGS. 3 to 10, however these are illustrative for the embodiments, and the invention is not limited thereto.

An osmotic pressure element may be used as the osmotic pressure generator 1 in the circulatory osmotic pressure power generation system 100. The osmotic pressure element is an osmotic pressure generator 1 having a volume of 1 to 20 L. A plurality of such osmotic pressure elements may be aggregated into an osmotic pressure module, which is used to integrate the pressures of these osmotic pressures into one pressure to be outputted. In the osmotic pressure module, if one of the osmotic pressure elements is degraded by wearing, it is possible to replace only the degraded one. Consequently, the maintenance efficiency and cost-effectiveness are high.

As is clear from the above description, a circulatory osmotic pressure power generation method may be provided as an embodiment.

In the circulatory osmotic pressure power generation system and method according to the embodiment, it is possible to recover high purity water by separation in the vaporization-separation unit. Therefore, it is possible to efficiently generate a flux in the osmotic pressure generator 1. Further, heating is performed using heat exhaust heat of a factory, an electricity generating plant, a public facility, and a house, ground heat, natural energy (e.g., sunlight energy) or the like, thereby improving the cost performance.

The separation operation and the transfer of the liquid after separation are simplified, and the operation cost can be reduced. Further, the working medium does not produce gas, and therefore the structure of the vaporization-separation unit can be simplified. Any component which damages the osmotic pressure generator, such as ammonia gas, is not generated, thereby reducing the maintenance cost of the apparatus as well as construction cost or plant operation cost.

As described above, the embodiment can provide a circulatory osmotic pressure power generation system that is operable at low cost.

The embodiment is different from the case of generating power through osmotic pressure using river water and sea water, and the liquid shut off from the outside may be used. As a result, the osmosis membrane in the osmotic pressure generator is not exposed to biotic contamination and it is possible to prolong the lifetime of the membrane, thereby reducing the cost.

Labor for maintenance during the process such as back washing can be significantly reduced, thereby prolonging the operation time and increasing the operation rate. Since ammonia gas is not used as the working medium, it is not necessary to use a multi-staged distillation system, thereby simplifying the system design. Further, the liquid can be recovered directly from each of the liquid phases after liquid-liquid separation via a pipeline. As the working medium, an optimal substance can be selected from substances having similar properties. Accordingly, the degree of freedom in system design is improved. Although ammonia is corrosive and toxic, safe one can be selected by phase control and the range of selection thereof can be expanded in the embodiment.

### (9) Ninth Embodiment

As described above, in the circulatory osmotic pressure power generation system and method according to the embodiment, it is possible to recover high purity water by separation in the vaporization-separation unit. A desalination system and a water purification system can be provided by using the operation which recovers high purity water. In other words, a desalination system or a water purification system may be provided as another embodiment.

A difference between the desalination system and the water purification system is that the object to be treated (i.e., a solution to be treated) is a liquid which should be desalinated or a liquid which should be purified. In both the desalination system and the water purification system according to the embodiment, water is separated from the solution to be treated in the osmotic pressure generator of the system, thus resulting in desalinated or purified water. Taking the desalination system as an example, the desalination system and the water purification system will be hereinafter described.

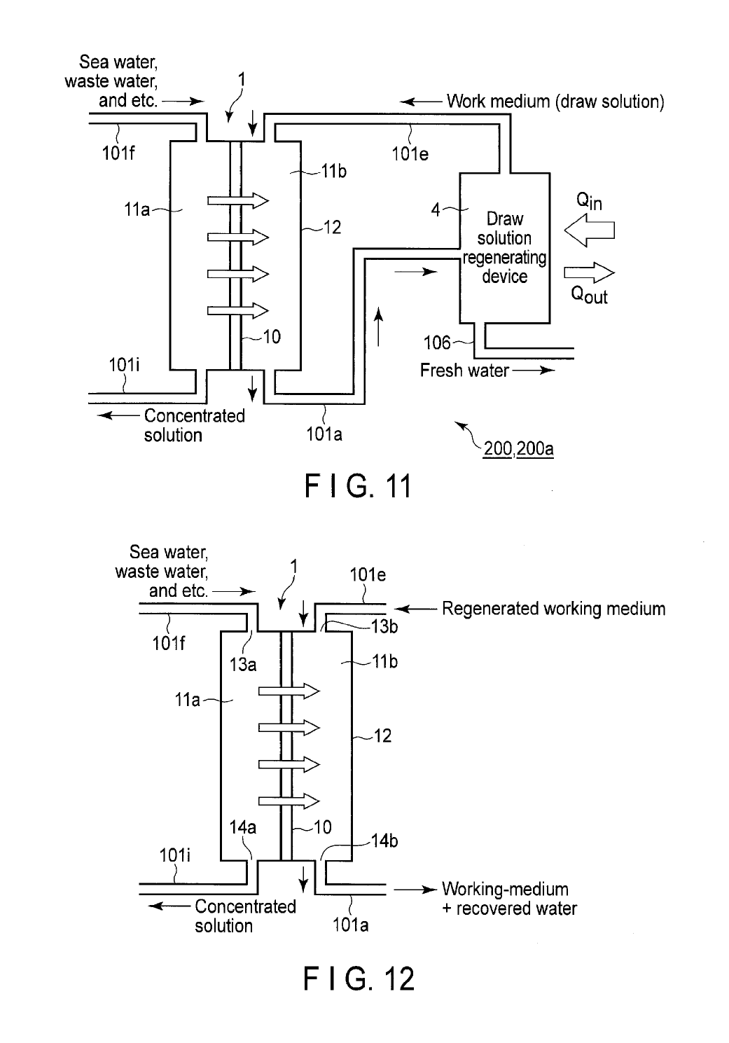

The desalination system will be described with reference to FIG. 11. FIG. 11 is a schematic diagram showing an example of the desalination system.

The desalination system 200 comprises a desalination device 200a and an acting medium which circulates through the desalination device 200a. The desalination device 200a comprises an osmotic pressure generator 1 and a vaporization-separation unit 4. As described below, the osmotic pressure generator 1 comprises two inlets and two outlets, which are similar to those used in the embodiments shown in FIGS. 6 to 10.

FIG. 12 shows a cross-sectional view of an example of the osmotic pressure generator 1. The osmotic pressure generator 1 comprises a treatment container 12 and an osmosis membrane 10. The osmosis membrane 10 is placed in the treatment container 12, the periphery of the membrane being fixed onto inner wall surfaces of the treatment container 12, thereby compartmentalizing the inside of the treatment container 12 into a first chamber 11a (left side of FIG. 12) and a second chamber 11b (right side of FIG. 12).

The upper and lower wall surfaces of the treatment container 12, in which the first chamber 11a is situated, have an opening of a first inlet 13a and an opening of a first outlet 14a, respectively. Through the first inlet 13a, the solution to be treated which should be desalinated is allowed to flow in. This solution is accommodated in the first chamber 11a. The upper and lower wall surfaces of the treatment container 12, in which the second chamber 11b is situated, have an opening of a second inlet 13b and an opening of a second outlet 14b, respectively. Through the second inlet 13b, the hyperosmotic solution is allowed to flow in. This solution is accommodated in the second chamber 11b. The solution to be treated which is accommodated in the first chamber 11a and the hyperosmotic solution which is accommodated in the second chamber 11b are disposed by the osmosis membrane 10 therebetween. In this state, an osmotic pressure difference is generated between the solution to be treated which is accommodated in the first chamber 11a and the hyperosmotic solution which is accommodated in the second chamber 11b. The water contained in the solution to be treated in the first chamber 11a is transferred to the second chamber 11b through the osmosis membrane 10 by the osmotic pressure difference. The water passing through the osmosis membrane 10 moves in a direction indicated by arrows in FIG. 12, namely a direction from the first chamber 11a to the second chamber 11b.

The solution to be treated is concentrated (or dehydrated) by the movement of the water passing through the osmosis membrane 10. The concentrated solution to be treated (concentrated solution) is discharged from the first chamber 11a via the first outlet 14a to outside the treatment container 12. The mixture containing the hyperosmotic solution in the second chamber 11b and the water transferred from the first chamber is discharged from the second chamber 11b via the second outlet 14b to outside the treatment container 12.

The desalination device 200a further comprises a pipeline which connects the osmotic pressure generator 1 and the vaporization-separation unit 4. One end of the pipeline 101a is connected to the second outlet 14b of the second chamber 11b and the other end is connected to the vaporization-separation unit 4. The pipeline 101a is a pipeline which transfers the mixture containing the hyperosmotic solution and the water moved by the osmotic pressure to the vaporization-separation unit 4. One end of the pipeline 101e is connected to the vaporization-separation unit 4 and the other end is connected to the second inlet 13b of the second chamber 11b. The pipeline 101e is a pipeline which transfers the hyperosmotic solution after separated from the water in the vaporization-separation unit 4 to the second chamber 11b of the osmotic pressure generator 1. The terminal end of a pipeline 101f for supplying sea water, waste water or the like to the first chamber 11a is connected to the first inlet 13a of the first chamber 11a. The starting end of a pipeline 101i for discharging the concentrated solution in the first chamber 11a is connected to the first outlet 14a.

The vaporization-separation unit 4 has the above-described structure. The water is separated from the hyperosmotic solution (working medium) by using the same structure and mechanism as those described in the embodiment. The separated working medium is regenerated by separation from water and transferred to the second chamber 11b of the osmotic pressure generator 1 through pipeline 101e.

Desalination of the solution to be treated is carried out as follows. The solution to be treated is transferred to the first chamber 11a of the osmotic pressure generator 1 through the pipeline 101f. The hyperosmotic solution is accommodated in the second chamber 11b. The hyperosmotic solution is supplied into the second chamber 11b through the second inlet 13b.

In the osmotic pressure generator 1, the solution to be treated is transferred to the second chamber 11b by the osmotic pressure difference generated between the solution to be treated and the hyperosmotic solution, which are disposed side by side through the osmosis membrane 10. The liquid (mixture) containing the transferred water and the hyperosmotic solution is transferred from the second outlet 14b to the vaporization-separation unit 4 via the pipeline 101a. In the vaporization-separation unit 4, the mixture is separated into water and a hyperosmotic solution. The separated and regenerated hyperosmotic solution is transferred to the second chamber 11b of the osmotic pressure generator 1 through the pipeline 101e and recycled. The water separated in the vaporization-separation unit 4 is recovered through the pipeline 106. Thus, the water is recovered from the solution to be treated, thereby achieving desalination. The concentrated solution dehydrated in the first chamber 11a may be transferred once again to the first chamber 11a via the pipeline 101i and the pipeline 101f and further dehydrated or may be recovered as a concentrated solution. The concentrated solution may be dehydrated by any method.

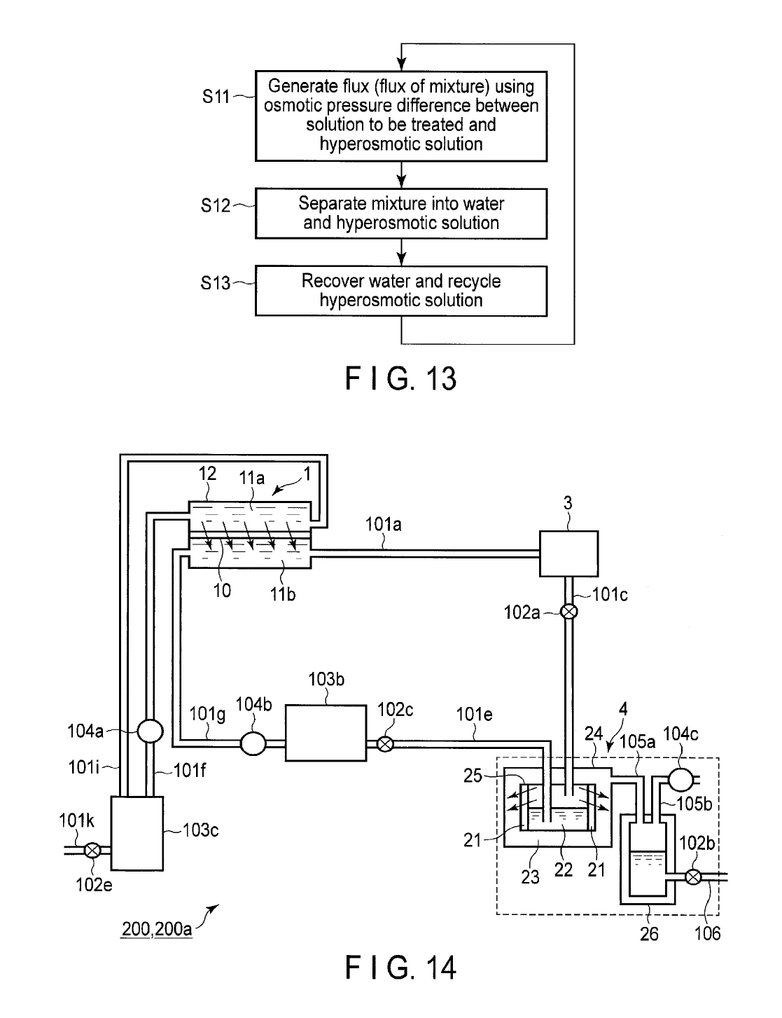

The water desalination method of the solution to be treated may include the steps shown in FIG. 13. A flux is generated by an osmotic pressure difference generated between the solution to be treated and the hyperosmotic solution (S11). This flux is generated by the mixture containing the water from the solution to be treated and the hyperosmotic solution accommodated in the second chamber 11b. The flux is transferred to the vaporization-separation unit 4, and then separated into water and a hyperosmotic solution (S12). The separated hyperosmotic solution is transferred to the second chamber 11b of the osmotic pressure generator 1 and recycled (S13).

In this way, the osmotic pressure is produced and regenerated repeatedly, thereby circulating the hyperosmotic solution in the generator.

The solution to be treated may be an aqueous liquid, an organic liquid, a mixed liquid obtained by mixing an aqueous liquid with an organic liquid, an inorganic solution, an organic solution, a mixed liquid obtained by mixing an inorganic solution with an organic solution, a mixed liquid obtained by mixing two or more kinds of these solutions, a liquid obtained by dissolving another substance in any of these solutions, or a liquid obtained by mixing another substance with any of these solutions. Examples of the aqueous liquid include water, methanol, ethanol and mixed liquid thereof. Examples of the organic liquid include toluene and/or acetone.

The solution to be treated may be, for example, a liquid obtained by dissolving inorganic salt and/or organic salt in any of the above liquids. Examples of the inorganic salt include sodium chloride, magnesium chloride, calcium chloride, sodium sulfate, magnesium sulfate, and/or potassium sulfate. Examples of the organic salt include sodium acetate, magnesium acetate, sodium citrate, and magnesium citrate. The solution to be treated may be a liquid in which any solute is dissolved in or mixed with an organic liquid, and further an aqueous liquid may be mixed therewith. Examples of the solute include organic substances such as fiber and/or resin. The solution to be treated may be a liquid in which any solute is dissolved in or mixed with an aqueous liquid, and further an organic liquid may be mixed therewith. Further, the solution to be treated may be sea water, lake water, river water, marsh water, domestic wasted water, industrial waste water or a mixture thereof. However, the solution to be treated is not limited to the liquids described above, and a practitioner may optionally select it.

In the desalination system shown in FIG. 11, a tank may be interposed in the pipeline 101a between the osmotic pressure generator 1 and the vaporization-separation unit 4. The tank accommodates the liquid from the osmotic pressure generator 1 and then the timing of allowing the liquid to flow into the vaporization-separation unit 4 is adjusted. Thus, the hyperosmotic solution (draw solution) in the vaporization-separation unit 4 is efficiently regenerated.

Further, in the desalination system shown in FIG. 11, the heat source 5 may be interposed in the pipeline 101c as shown in FIGS. 4 to 7 as described above. Consequently, it is possible to separate water from the mixture more smoothly or efficiently.

In the desalination system shown in FIG. 11, in order to exchange the pressure between the pipelines 101e and 101a, the pressure exchanger 6 as shown in FIG. 5, and FIGS. 7 to 10 may be interposed and bridged over between the pipelines 101e and 101a.

An example of the desalination system has been described, and this embodiment can be used as the water purification system.

The desalination system or the water purification system simplifies the separation operation and the transfer of the liquid after separation and the operation cost can be reduced. Further, the working medium does not produce gas, and therefore the structure of the vaporization-separation unit can be simplified. Any component which damages the osmotic pressure generator, such as ammonia gas, is not generated, thereby reducing the maintenance cost of the apparatus as well as construction cost or plant operation cost. The embodiment can provide a desalination or water purification system that is operable at low cost.

The solution to be treated is desalinated by the desalination system. According to the desalination system of the embodiment, it is possible to recover high purity water (e.g., fresh water) from the solution to be treated with low energy.

The term “water treatment system” herein means a system configured to include a water treatment apparatus 200) which comprises the osmotic pressure generator 1 and the vaporization-separation unit 4; and a draw solution (i.e., a hyperosmotic solution). Therefore, the water treatment system according to the embodiment may be any of the power generation system, desalination system and/or water purification system. In other words, the water treatment system includes all the systems as described above. Any one of these systems is selected, the structure of the selected system is combined with a part of the structures included in other systems and the combined structure may be incorporated into the selected system.

For example, in the osmotic pressure power generation system described above, water permeates through the osmosis membrane in the osmotic pressure generator 1, thereby generating a flux. After generating power by the flux, first and second liquids (i.e., water and a hyperosmotic solution) are transferred to the vaporization-separation unit 4 and separated into water and a hyperosmotic solution therein. The water and the hyperosmotic solution are regenerated by separation. The regenerated water and hyperosmotic solution as the first and second liquids are transferred to the osmotic pressure generator 1. In other words, the water (the first liquid) in the osmotic pressure power generation system is a “solution to be treated”.

On the other hand, in the desalination system and the water purification system, a solution to be treated which should be desalinated or purified (i.e., the first liquid) and a hyperosmotic solution (i.e., the second liquid) are disposed side by side in the osmotic pressure generator 1 which is interposed the osmosis membrane therebetween. In the osmotic pressure generator 1, the water in the solution to be treated permeates the osmosis membrane. The resulting mixture is transferred to the vaporization-separation unit 4. The vaporization-separation unit 4 separates the mixture into water and a hyperosmotic solution. As the regenerated second liquid, the hyperosmotic solution obtained by separation is transferred to the osmotic pressure generator 1. The separated water is recovered as the desalinated or purified water.

The common structure of these water treatment systems consists of, for example, comprising a combination of the osmotic pressure generator 1 and the vaporization-separation unit 4 and circulating the hyperosmotic solution while repeatedly regenerating it.

### (10) Tenth Embodiment

The embodiment will be described with reference to FIG. 14. This embodiment is an example of the desalination system or the water purification system.

This system is an example in which the desalination device 200a shown in FIG. 11 further comprises a buffer tank 3 interposed in a pipeline, a hyperosmotic solution tank 103b, and a solution to be treated tank 103c.

The desalination device 200a has the following structure. A second outlet of an osmotic pressure generator 1 is connected to the buffer tank 3 via a pipeline 101a. The buffer tank 3 is connected to a vaporization-separation unit 4 via a pipeline 101c. Specifically, the pipeline 101c is connected to a third chamber 22 of a separation part 25 of the vaporization-separation unit 4. The third chamber 22 is connected to the hyperosmotic solution tank 103b via a pipeline 101e. The hyperosmotic solution tank 103b is connected to a second chamber 11b of the osmotic pressure generator 1 via a pipeline 101g.

In the separation part 25 of the vaporization-separation unit 4, the evaporation water transferred from the third chamber 22 to the fourth chamber 23 through a zeolite membrane 21 is transferred to a water trap 26 via a pipeline 105a and accumulated as a liquid. The water accumulated in the buffer tank 3 is discharged through a pipeline 106 when an on-off valve 102b is opened.

The solution to be treated tank 103c is connected to a first inlet of a first chamber 11a of the osmotic pressure generator 1 via a pipeline 101f. The first outlet of the first chamber 11a is connected to the solution to be treated tank 103c via a pipeline 101i. The starting end of a pipeline 101k is connected to the solution to be treated tank 103c. An on-off valve 102e is interposed in the pipeline 101k in order to control inflow and/or outflow of the solution to be treated into the solution to be treated tank 103c. The solution to be treated tank 103c may further comprise an opening connected to another pipeline, in addition to the pipeline 101k. Accordingly, either another pipeline or the pipeline 101k can be used for inflow or discharge.

In the desalination system 200 which comprises the desalination device 200a, a hyperosmotic solution is included as the working medium. The hyperosmotic solution is also referred to as “draw solution”. In an initial state, the draw solution is accommodated in the second chamber 11b. The solution to be treated is accommodated in the solution to be treated tank 103c, and the solution is transferred to the first chamber 11a via the pipeline 101f by operating a pump 104a interposed in the pipeline 101f. The solution to be treated and the draw solution are disposed side by side while interposing an osmosis membrane 10 therebetween, thereby generating an osmotic pressure difference. The water of the solution to be treated in the first chamber 11a is transferred from the first chamber 11a to the second chamber 11b by the osmotic pressure difference. The mixture, which is a liquid containing the transferred water and the hyperosmotic solution, is transferred to the buffer tank 3 via the pipeline 101a. An on-off valve 102a interposed in the pipeline 101c is opened or closed depending on the operation state in the vaporization-separation unit 4. When the on-off valve 102a is opened, the mixture accommodated in the buffer tank 3 is transferred to the third chamber 22 of the separation part 25 via the pipeline 101c.

The draw solution separated from the water in the separation part 25 is transferred to the hyperosmotic solution tank 103b via the pipeline 101e. The draw solution accommodated in the hyperosmotic solution tank 103b is transferred to the second chamber 11b of the osmotic pressure generator 1 by operating a pump 104b interposed in the pipeline 101g.

In this system, it is possible to repeatedly dehydrate the solution to be treated which should be desalinated or purified in the osmotic pressure generator 1.

The desalination system can be used as the water purification system.

The solution to be treated is desalinated by the desalination system. According to the desalination system of the embodiment, it is possible to recover high purity water (e.g., fresh water) from the solution to be treated with low energy.

Further, in the desalination system shown in FIG. 14, the heat source 5 may be interposed in the pipeline 101c as shown in FIGS. 4 to 7 as described above. Consequently, it is possible to separate water from the mixture more smoothly or efficiently.

In the desalination system shown in FIG. 14, in order to exchange the pressure between the pipelines 101g and 101a, the pressure exchanger 6 as shown in FIG. 5, and FIGS. 7 to 10 may be interposed and bridged over between the pipelines 101g and 101a.

The desalination system or the water purification system simplifies the separation operation and the transfer of the liquid after separation and the operation cost can be reduced.

### (11) Eleventh Embodiment

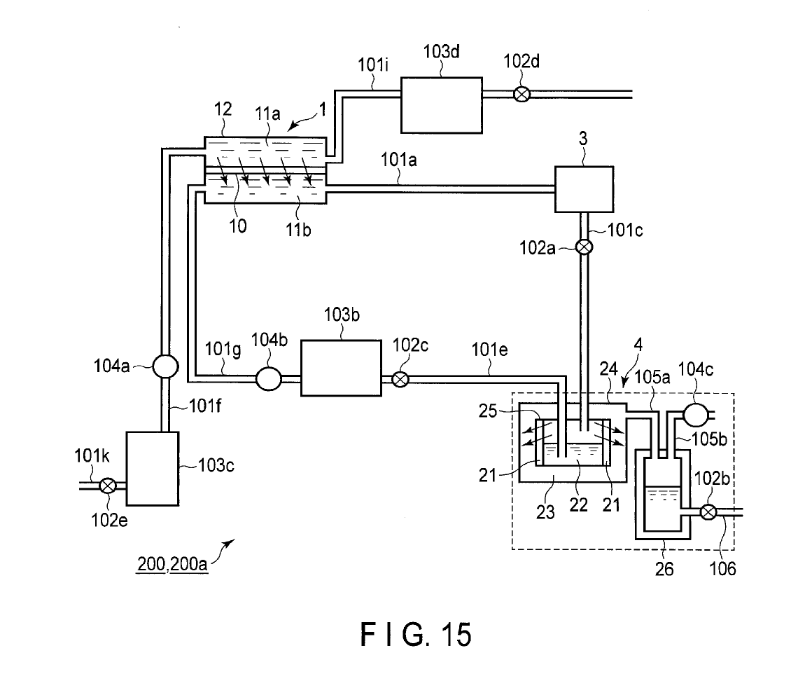

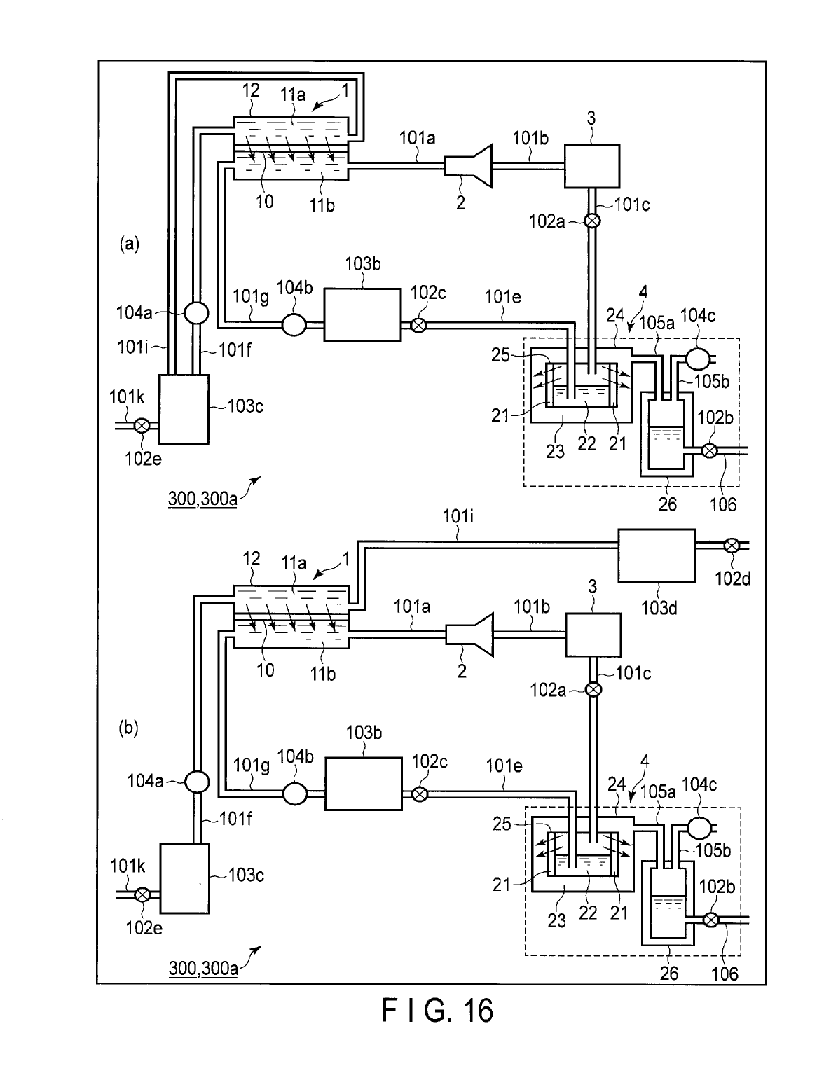

Another example of the desalination system and/or water purification system will be described with reference to FIG. 15. In the system of FIG. 15, the desalination device 200a has the same structure as that of the system shown in FIG. 14 except that it further comprises a concentrated solution tank 103d.

In this embodiment, the solution to be treated which should be introduced into a first chamber 11a of an osmotic pressure generator 1 is transferred from a solution to be treated tank 103c to the first chamber 11a via a pipeline 101f by operating a pump 104a. The concentrated solution dehydrated in the osmotic pressure generator 1 is transferred to the concentrated solution tank 103d through a first outlet and a pipeline 101i and accommodated therein. An on-off valve 102d is opened to allow the concentrated solution accommodated in the concentrated solution tank 103d to discharge to the outside.

On the other hand, the osmotic pressure is produced and regenerated repeatedly, thereby circulating the hyperosmotic solution in the generator.

The desalination system can also be used as the water purification system.

The solution to be treated is desalinated by the desalination system. According to the desalination system of the embodiment, it is possible to recover high purity water (e.g., fresh water) from the solution to be treated with low energy.

The desalination system or the water purification system simplifies the separation operation and the transferring of the liquid after separation, and the operation cost can be reduced.

### (12) Twelfth and Thirteenth Embodiments

As another embodiment, there is provided a system which simultaneously performs power generation, desalination, and/or water purification. FIGS. 16 (a) and (b) show the examples thereof. These systems may have the same structures as those of the systems shown in FIGS. 14 and 15 except for comprising a turbine 2 for power generation, which interposes in a pipeline 101a between a first osmotic pressure generator 1 and a buffer tank 3.

Osmotic pressure power generation can be performed in the same manner as the above-described apparatus and system. In the system, a flux is generated in the osmotic pressure generator 1, the generated flux rotates the turbine 2, thus electric power is generated, and then the hyperosmotic solution included in the flux is regenerated in a vaporization-separation unit 4. The regenerated hyperosmotic solution is transferred to the second chamber 11b of the osmotic pressure generator 1 and recycled. Hence, the hyperosmotic solution circulates in the system.

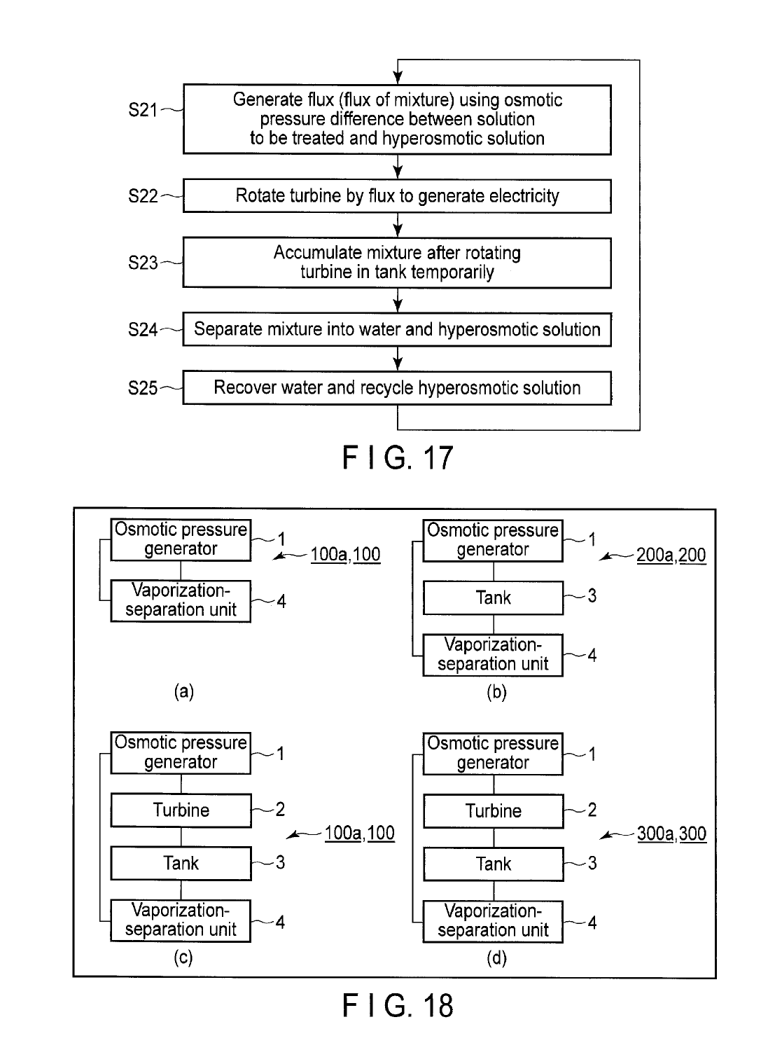

For example, the water treatment method according to the embodiment may include the step shown in FIG. 17. This water treatment method may include the steps of: generating a flux (i.e., flux generated by a mixture) by an osmotic pressure difference generated between a solution to be treated and a hyperosmotic solution (S21); rotating a turbine by the flux to generate power (S22); temporarily accumulating the mixture after rotating the turbine in a buffer tank (S23); separating the mixture into water and a hyperosmotic solution in a vaporization-separation unit (S24); recovering the obtained water (S25); and recycling the obtained hyperosmotic solution to osmotic pressure generation (S25 and S21).

In this regard, in the desalination system shown in FIGS. 16 (a) and (b), a heat source 5 may be further interposed in a pipeline 101c as shown in FIGS. 4 to 7. Consequently, it is possible to separate water from the mixture more smoothly or efficiently.

In the desalination system shown in FIGS. 16 (a) and (b), in order to exchange the pressure the pipelines 101g and 101a, the pressure exchanger 6 as shown in FIG. 5, and FIGS. 7 to 10 may be interposed and bridged over between the pipelines 101g and 101a.

The water treatment system simplifies the separation operation to regenerate the hyperosmotic solution and the transferring of the liquid after separation, and the operation cost can be reduced. Further, the working medium does not produce gas, and therefore the structure of the vaporization-separation unit can be simplified. Any component which damages the osmotic pressure generator, such as ammonia gas, is not generated, thereby reducing the maintenance cost of the apparatus as well as construction cost or plant operation cost. The embodiment can provide a water treatment system that is operable at low cost.

The solution to be treated is desalinated by the water treatment system. According to the water treatment system of the embodiment, it is possible to recover high purity water (e.g., fresh water) from the solution to be treated with low energy.

### (13) Fourteenth Embodiment

The water treatment system according to the embodiment will be described with reference to FIGS. 18 (a) to (d).

A water treatment system 100 includes a water treatment apparatus 100a and a draw solution. The draw solution may be the above-described hyperosmotic solution. The water treatment apparatus 100a comprises an osmotic pressure generator 1 and a vaporization-separation unit 4 as shown in FIG. 18 (a). The osmotic pressure generator 1 and the vaporization-separation unit 4 are connected to, for example, pipelines. In the osmotic pressure generator 1, the water in the solution to be treated is transferred to the draw solution through an osmosis membrane 10 by an osmotic pressure difference generated between the draw solution and the solution to be treated. The resulting mixture containing the draw solution and the water is transferred to the vaporization-separation unit 4 and separated the mixture into a draw solution and water. The draw solution regenerated by the separation is transferred to the osmotic pressure generator 1 and repeatedly used.

Water treatment in the osmotic pressure generator 1 is performed by drawing at least a portion of water contained in the solution to be treated into the draw solution through the osmosis membrane 10. The water drawn by the draw solution may be recovered by separating it from the draw solution in the vaporization-separation unit 4 or the separated water may be repeatedly used by transferring it to the osmotic pressure generator 1.

As shown in FIG. 18 (b), the water treatment apparatus 100a may include a tank 3 interposed between the osmotic pressure generator 1 and the vaporization-separation unit 4. In the osmotic pressure generator 1, the resulting mixture containing the draw solution and water is once stored in the tank 3. The mixture accommodated in the tank is transferred to the vaporization-separation unit 4 depending on the separation working state of the vaporization-separation unit 4.

In order to impart a function of generating power to the water treatment system, the function may be such that the turbine is rotated by the mixture flux generated by pulling water by the draw solution in the osmotic pressure generator 1. The draw solution is regenerated by transferring the mixture after rotating the turbine to the vaporization-separation unit 4 and separating it from water. The separated water is recovered as purified water. The water treatment system comprises, for example, a power generating apparatus. An example of power generating apparatus 100a, 300a comprises an osmotic pressure generator 1, a turbine 2, a tank 3, and a vaporization-separation unit 4 as shown in FIGS. 18 (c) and (d). The power generation system 100 comprises a power generating apparatus 100a and a working medium. The working medium includes water or a treatment solution as the solution to be treated and a hyperosmotic solution as the draw solution.

In order to impart a function of desalination and/or water purification to the water treatment system, it may be configured that the draw solution as well as the solution which should be desalinated or purified (i.e., a treatment solution as the solution to be treated) are accommodated in the osmotic pressure generator 1. In the osmotic pressure generator 1, the concentrated solution after dehydrating at least a portion of water by drawing water into the draw solution may be directly discarded, or may be repeatedly desalinated and/or purified by circulating and transferring it to the osmotic pressure generator 1.

In an example, a desalination and/or water purification device 200a comprises an osmotic pressure generator 1, an optional tank 3, and a vaporization-separation unit 4 as shown in FIGS. 18 (a) and (b). The power generation system 100 comprises an electric power generating apparatus 100a and a working medium. The working medium includes water or a treatment solution and a hyperosmotic solution as the draw solution. Alternatively, as another example, the water purification device 200a may include the turbine 2 as shown in FIGS. 18 (c) and (d).

For example, like the twelfth and thirteenth embodiments, the water treatment system for performing power generation and desalination and/or water purification may be switchable so that only either one of power generation and desalination and/or water purification is performed as desired. A desired treatment may be achieved by including the osmotic pressure generator 1, the turbine 2 and/or the tank 3, and the vaporization-separation unit 4, a plurality of pipelines which connects these, on-off valves interposed in these pipelines, and switching the on and off the valves. As desired, in order to generate power, at least a portion of water separated in the vaporization-separation unit 4 may be again transferred to the osmotic pressure generator 1 and recycled.

The water treatment system simplifies the separation operation to regenerate the draw solution and the transferring of the liquid after separation, and the operation cost can be reduced. Further, the working medium does not produced gas, and therefore the structure of the vaporization-separation unit can be simplified. Any component which damages the osmotic pressure generator, such as ammonia gas, is not generated, thereby reducing the maintenance cost of the apparatus as well as construction and plant operation costs. The embodiment can provide a water treatment system that is operable at low cost.

### (14) Fifteenth Embodiment

The water treatment method according to the embodiment is, for example, a water treatment method as described below. The method uses a water-containing solution to be treated and a working medium containing a draw solution, the draw solution being a hyperosmotic solution which generates an osmotic pressure difference with water. The method may include any of the following procedures (1) to (4).

(1) A method includes the steps of:

(a) in an osmotic pressure generator which includes a first chamber and a second chamber compartmentalized by an osmosis membrane, generating a flux of a mixture containing the water and the hyperosmotic solution by an osmotic pressure difference generated between the solution to be treated which is accommodated in the first chamber and the draw solution which is accommodated in the second chamber;

(b) in a vaporization-separation unit which includes a third chamber and a fourth chamber compartmentalized by a zeolite membrane, transferring the flux of the mixture to the third chamber;

(c) transferring water permeated through the zeolite membrane from the third chamber to the fourth chamber by a pressure difference between the fourth chamber and the third chamber to separate the water from the draw solution; and

(d) allowing the draw solution which is separated by the vaporization-separation unit to accommodate in the second chamber of the osmotic pressure generator.

Such a procedure is included, whereby it is possible to provide a water treatment method configured to use a hyperosmotic solution which generates an osmotic pressure difference with water as the draw solution. This treatment method is a water treatment technique that is operable at low cost because it can be used, for example, desalination, water purification, and/or power generation.

(2) A method includes the steps of:

(a) in an osmotic pressure generator which includes a first chamber and a second chamber compartmentalized by an osmosis membrane, generating a flux of a mixture containing the water and the draw solution by an osmotic pressure difference generated between the solution to be treated which is accommodated in the first chamber and the draw solution which is accommodated in the second chamber;

(b) in a vaporization-separation unit which includes a third chamber and a fourth chamber compartmentalized by a zeolite membrane, transferring the flux of the mixture to the third chamber;

(c) transferring water permeated through the zeolite membrane from the third chamber to the fourth chamber by a pressure difference between the fourth chamber and the third chamber to separate the water from the draw solution;

(d) allowing the draw solution which is separated by the vaporization-separation unit to accommodate in the second chamber of the osmotic pressure generator; and

(e) recovering the water separated by the vaporization-separation unit.

Such a procedure is included, whereby it is possible to provide a water treatment method which desalinates or purifies a water-containing solution to be treated using a hyperosmotic solution which generates an osmotic pressure difference with water as the draw solution. The method is a water treatment technique that is operable at low cost.

(3) A method includes the steps of:

(a) in an osmotic pressure generator which includes a first chamber and a second chamber compartmentalized by an osmosis membrane, generating a flux of a mixture containing the water and the draw solution by an osmotic pressure difference generated between the solution to be treated which is accommodated in the first chamber and the draw solution which is accommodated in the second chamber;

(b) rotating a turbine by the flux of the mixture to generate power;

(c) in a vaporization-separation unit which includes a third chamber and a fourth chamber compartmentalized by a zeolite membrane, transferring the mixture after rotating the turbine to the third chamber;

(d) transferring water permeated through the zeolite membrane from the third chamber to the fourth chamber by a pressure difference between the fourth chamber and the third chamber to separate the water from the draw solution; and

(e) returning the water and the draw solution separated by the vaporization-separation unit to the first chamber and the second chamber of the osmotic pressure generator, respectively and allowing them to accommodate therein.

Such a procedure is included, whereby it is possible to provide a water treatment method which generates power using a hyperosmotic solution which generates an osmotic pressure difference with water as the draw solution. The method is a water treatment technique that is operable at low cost.

(4) A method includes the steps of:

(a) in an osmotic pressure generator which includes a first chamber and a second chamber compartmentalized by an osmosis membrane, generating a flux of a mixture containing the water and the hyperosmotic solution by an osmotic pressure difference generated between the solution to be treated which is accommodated in the first chamber and the draw solution which is accommodated in the second chamber;

(b) rotating a turbine by the flux of the mixture to generate power;

(c) in a vaporization-separation unit which includes a third chamber and a fourth chamber compartmentalized by a zeolite membrane, transferring the mixture after rotating the turbine to the third chamber;

(d) transferring water permeated through the zeolite membrane from the third chamber to the fourth chamber by a pressure difference between the fourth chamber and the third chamber to separate the water from the hyperosmotic solution;

(e) returning the draw solution separated by the vaporization-separation unit to the second chamber of the osmotic pressure generator and allowing it to accommodate therein; and

(f) recovering the water separated by the vaporization-separation unit.

Such a procedure is included, whereby it is possible to provide a water treatment method which generates power and desalinates or purifies a water-containing solution to be treated using a hyperosmotic solution which generates an osmotic pressure difference with water as the draw solution. The method is a water treatment technique that is operable at low cost.

The water treatment method simplifies the separation operation to regenerate the hyperosmotic solution as the draw solution and the transferring of the liquid after separation and the operation cost can be reduced. Further, the working medium does not produce gas, and therefore the structure of the vaporization-separation unit can be simplified. Any component which damages the osmotic pressure generator, such as ammonia gas, is not generated, thereby reducing the maintenance cost of the apparatus as well as construction and plant operation costs. The embodiment can provide a water treatment method that is operable at low cost.

### EXAMPLES

### (1) Syringe Test Device

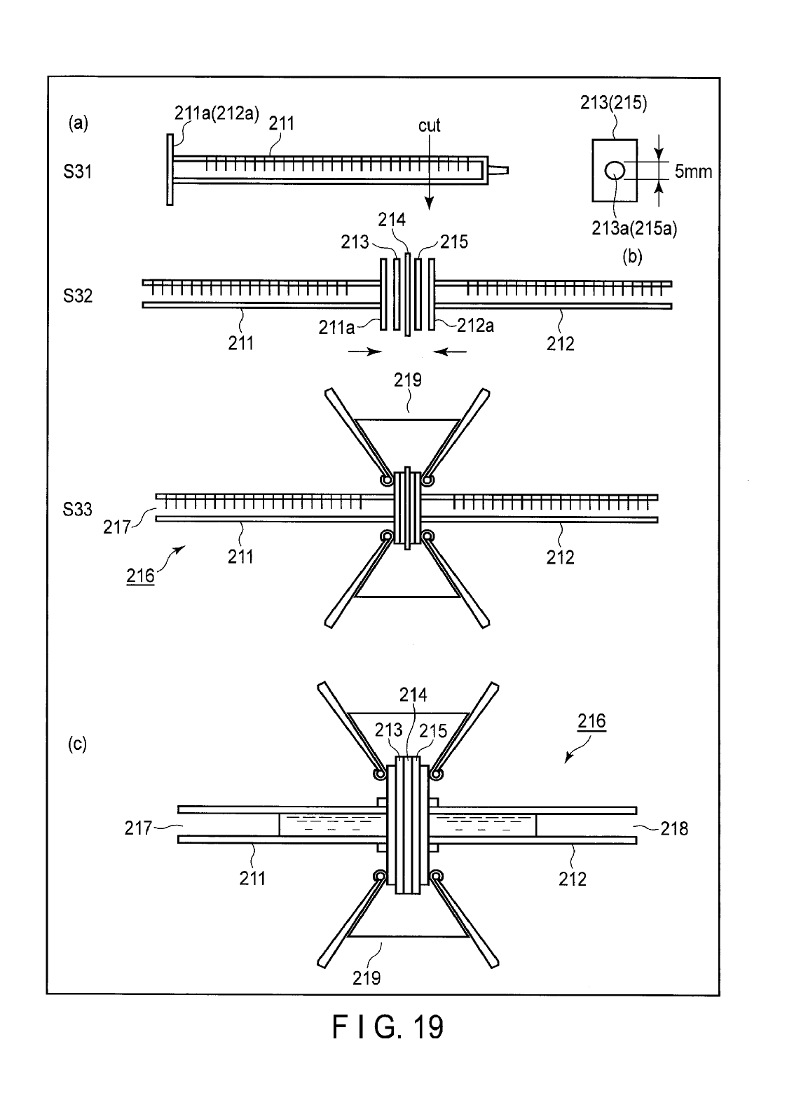

A manufacturing process of a syringe test device will be described with reference to FIG. 19 (a).

First, 1 mL-disposable plastic syringes 211 and 212 having grip portions 211a and 212a at one end thereof were prepared. In each of the syringes 211 and 212, a distal end to which an injection needle is to be set was cut out (S31). The grip portions 211a and 212a of the two cut syringes 211 and 212 were set to face each other, and two rubber pieces 213 and 215 and an osmosis membrane 214 were interposed therebetween (S32). They were interposed in the order of the first syringe 211, the first rubber sheet 213, the osmosis membrane 214, the second rubber piece 215, and the second syringe 212. Then, they were fixed together with a clip 219 (S33). As described above, a syringe test device 216 was obtained.

As the osmosis membrane 214, ES20, which is an RO membrane manufactured by Nitto Denko Corporation, was used. As the first and second rubber pieces 213 and 215, rubber disks were used. As shown in FIG. 19 (b), a circular hole 213a (215a) having a diameter of 5 mm is opened in each rubber piece 213 (215).

### (2) Syringe Test

### Example 1

A syringe test device 216 was produced in accordance with the procedure (1). Glycerin was injected to the first syringe 211 and fresh water was injected to the second syringe 212 (shown in FIG. 19 (c)). During steps S31 and S32 shown in FIG. 19 (a), the liquids used for the test were injected to the syringes 211 and 212, respectively.

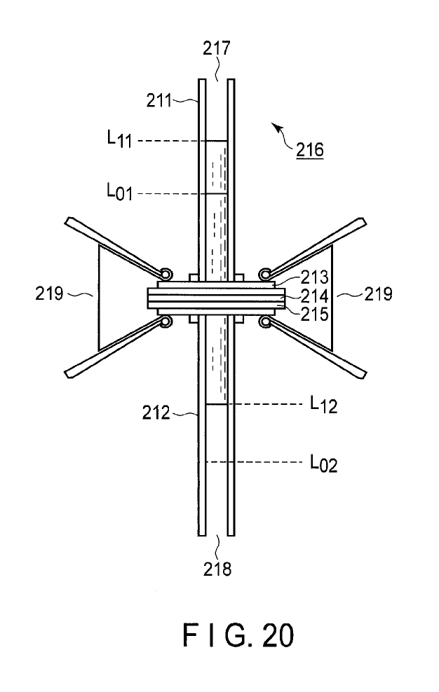

Then, the first syringe 211 was arranged vertically so as to be located in an upper section of the second syringe 212, they were let stand at 25° C. under a pressure of 1 atm. This situation is shown in FIG. 20. Thereafter, the scale was read at time intervals of 5 minutes, 10 minutes, 20 minutes, 30 minutes, 1 hour, 2 hours, 3 hours, 4 hours, and 5 hours, and the migration of water from the side of the second syringe 212 to the side of the first syringe 211 was measured. In this regard, the liquid injected into the syringe test device 216 did not leak outside in the step of manufacturing the syringe test device 216 or during the test. In this regard, in FIG. 20, L₀₁ denotes a first liquid level of the first syringe 211, L₁₁ denotes a liquid level after the test of the first syringe 211. In FIG. 20, L₀₂ denotes a first liquid level of the second syringe 212, and L₁₂ denotes a liquid level after the test of the first syringe 211.

### <Results>

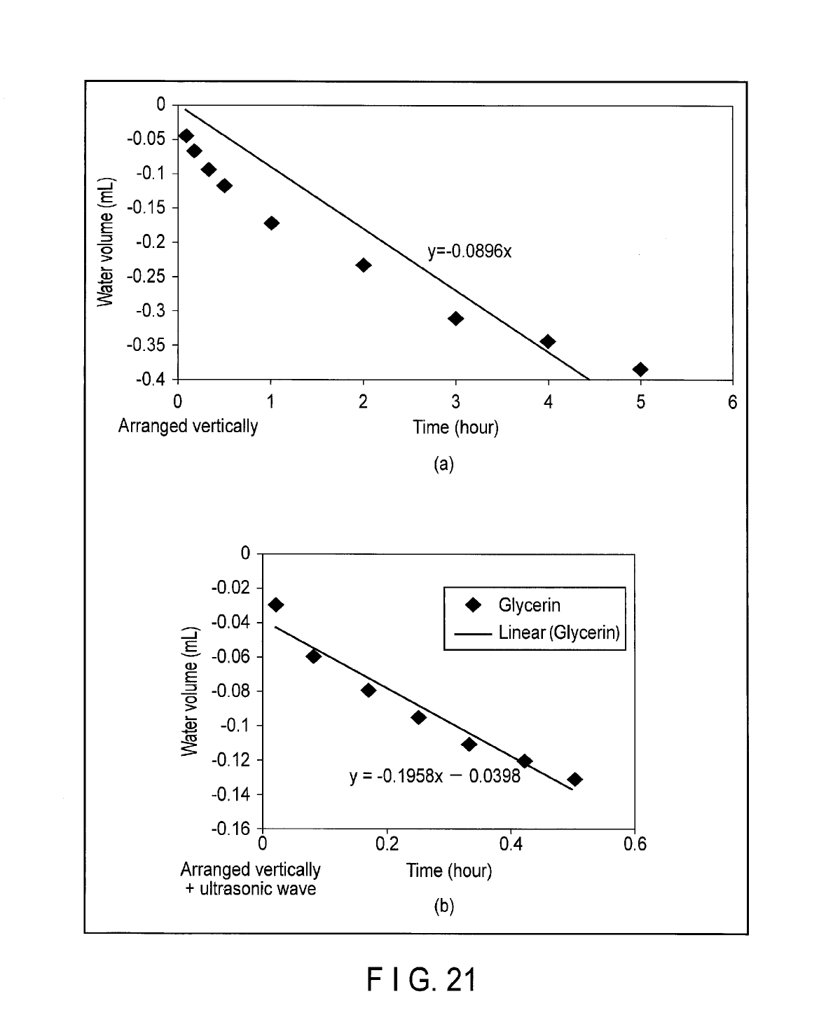

The results are shown in FIG. 21 (a). The horizontal axis represents time, whereas the vertical axis represents the flow in milliliters (mL) as unit in FIG. 21 (a). The dotted curve represents the actual measured value of the flow. As shown by the dotted curve of FIG. 21 (a), the initial speed (slope in the graph) was decreased as time passed. This is considered to be because water permeates the osmosis membrane and upwardly moves from the second syringe 212 to the first syringe 211 and the water exists around the osmosis membrane at the side of the first syringe 211, resulting in a concentration polarization effect. The straight line in FIG. 21 (a) represents an average of the initial speed (5 minutes) and the final speed (5 hours) in the dotted graph.

### Example 2

A syringe test device 216 was produced in the same manner as in Example 1. Glycerin was injected to the first syringe 211 and fresh water was injected to the second syringe 212. In Example 1, there was an influence on the concentration polarization. In order to eliminate the influence, an ultrasonic wave was applied to the outside of the first syringe 211 disposed at the upper part using a sonicator over the whole test period. The syringe scale was read periodically and the migration of water from the side of the second syringe 212 to the side of the first syringe 211 was measured. Except this, the test was performed in the same manner as in Example 1.

### <Results>

The results were shown in FIG. 21 (b). The horizontal axis represents time, whereas the vertical axis represents the flow in milliliters (mL) as unit in FIG. 21 (b). The dotted curve represents the actual measured value of the flow. The straight line in FIG. 21 (b) shows data on the gradient (speed) equalized based on the actual measured values indicated by the dots. As is clear from FIG. 21 (b), the migration of water was faster than the result of Example 1 due to ultrasonic stirring and it was a constant speed.

### Example 3

A syringe test device 216 was produced in accordance with the procedure (1). Glycerin and 2,2,3,3,3-pentafluoro-1-propanol (PF1P) were injected to the first syringe 211. Fresh water was injected to the second syringe 212. For comparison, a syringe test device 216 having a first syringe 211 to which 3.5 wt % of sea water was injected was prepared. During steps (S31) and (S32) shown in FIG. 19 (a), the liquids used for the test were injected to the syringes 211 and 212, respectively. The test was performed in the same manner as in Example 2. The syringe scale was read periodically and the migration of water from the side of the second syringe 212 to the side of the first syringe 211 was measured.

### <Results>

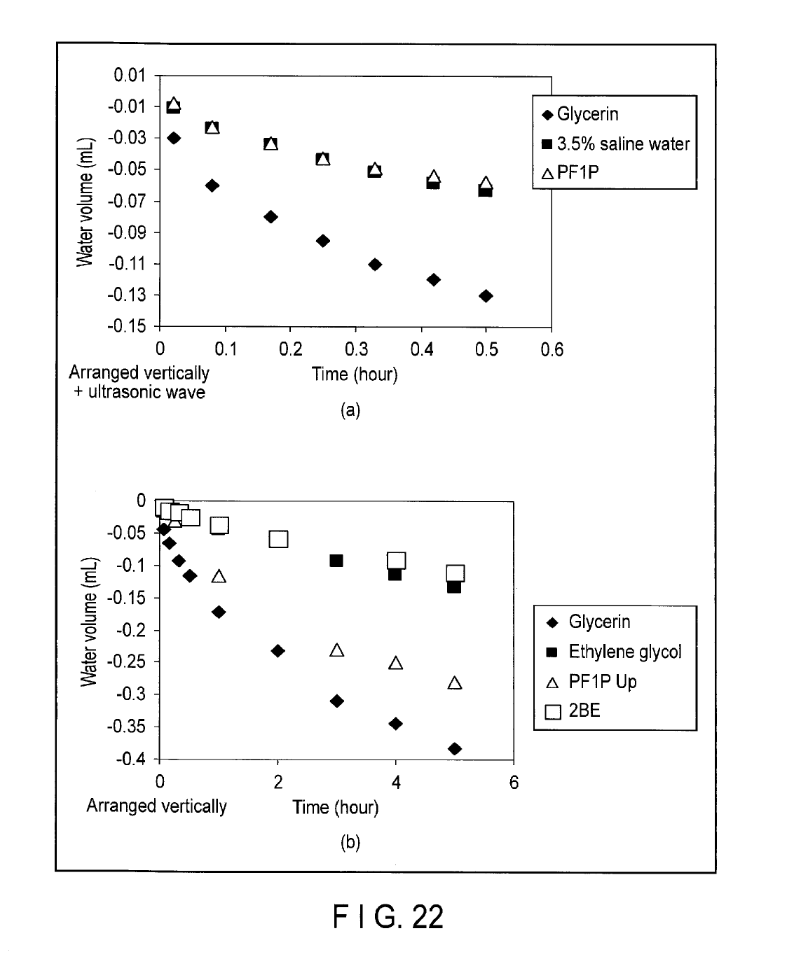

The results were shown in FIG. 22 (a). When PF1P or 3.5% saline water was injected to the first syringe 211, the migration of water was reduced compared to when glycerin was injected. Hence, the migration speed of water was slow. This result shows that glycerin is an excellent hyperosmotic solution.

### Example 4

A syringe test device 216 was produced in accordance with the procedure (1). Glycerin, ethylene glycol, 2,2,3,3,3-pentafluoro-1-propanol (PF1P), 100% 2-butoxyethanol (2BE) were injected to the first syringe 211. Fresh water was injected to the second syringe 212. Glycerin after changing its concentration was prepared. During steps (S31) and (S32) shown in FIG. 19 (a), the liquids used for the test were injected to the syringes 211 and 212, respectively. The test was performed in the same manner as in Example 2. Then, the scale was read at time intervals of 5 minutes, 10 minutes, 15 minutes, 20 minutes, 30 minutes, 1 hour, 2 hours, 3 hours, 4 hours, and 5 hours, and the migration of water from the side of the second syringe 212 to the side of the first syringe 211 was measured.

### <Results>

The results were shown in FIG. 22 (b). When glycerin or ethylene glycol was injected to the first syringe 211, the migration of water was increased compared to when PF1P or 2BE was injected. The migration speed of water was also fast. This result shows that glycerin and ethylene glycol are excellent hyperosmotic solutions.

### Example 5

A syringe test device 216 was produced in accordance with the procedure (1). Glycerins having mutually different concentrations were injected to the first syringe 211. Fresh water was injected to the second syringe 212. The used glycerins had concentrations of 100 wt %, 80 wt %, 70 wt %, and 50 wt %. The glycerins having these concentrations were used to produce the syringe test device 216. During steps (S31) and (S32) shown in FIG. 19 (a), the liquids used for the test were injected to the syringes 211 and 212, respectively. The test was performed in the same manner as in Example 2. Then, the scale was read at time intervals of 5 minutes, 10 minutes, 20 minutes, 30 minutes, 1 hour, 2 hours, 3 hours, 4 hours, and 5 hours, and the migration of water from the side of the second syringe 212 to the side of the first syringe 211 was measured.

### <Results>

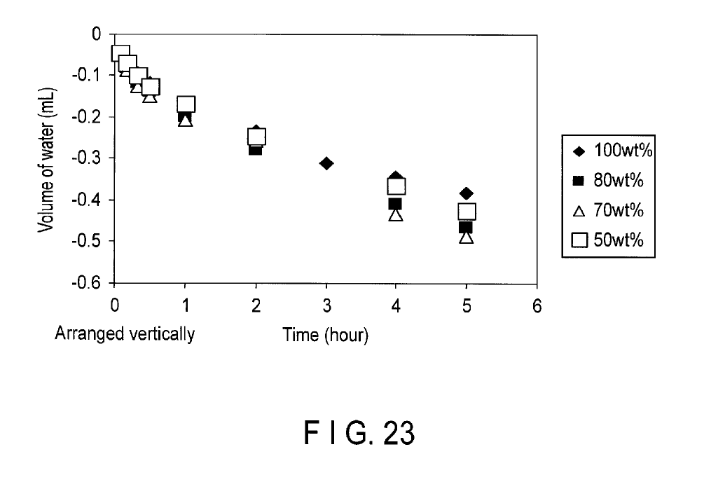

The results were shown in FIG. 23. These results indicate that the concentrations of glycerins are seemed not to have a large influence on the migration of water.

### Example 6

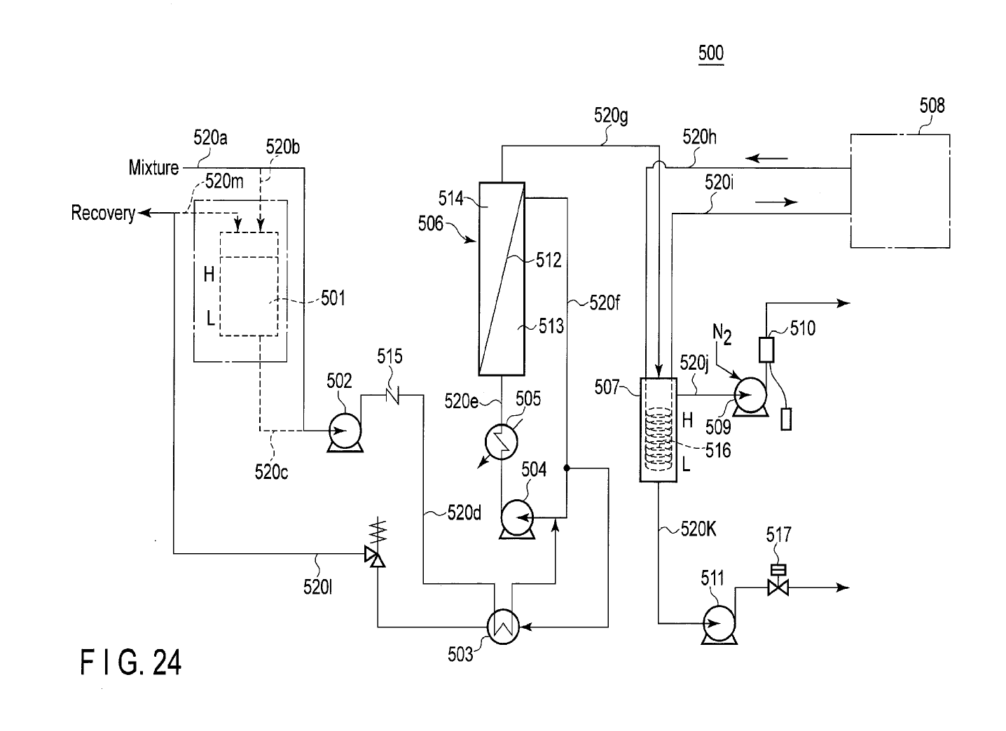

A test for separating water and a hyperosmotic solution (solvent described below) was performed by the pervaporation method using MSM-1, manufactured by Mitsubishi Chemical Corporation. A middle-size device was used for the test. FIG. 24 schematically shows an apparatus which is used.

This device 500 comprises a mixture tank 501, a liquid transfer pump 502, a heat recovery device 503, a circulation pump 504, a heater 505, a dehydrator 506, a condenser 507, a coolant-circulation device 508, a vacuum pump 509, an oil mist trap 510, and a liquid discharge pump 511. A water removal membrane 512 compartmentalizes the dehydrator 506 into a first chamber 513 and a second chamber 514. As the water removal membrane 512, a zeolite membrane (e.g., MSM-1, manufactured by Mitsubishi Chemical Corporation) was used.

One end of a pipeline 520a is connected to the liquid transfer pump 502, and the mixture is supplied to the liquid transfer pump 502 via the pipeline 520a. One end of a pipeline 520b branched from the pipeline 520a is connected to the mixture tank 501. The lower part of the mixture tank 501 is connected to the pipeline 520a near the liquid transfer pump 502 via a pipeline 520c. The liquid transfer pump 502 is connected to the circulation pump 504 via a pipeline 520d passing through the heat recovery device 503 and a pipeline 520f to be described below. A first on-off valve 515 is interposed in the pipeline 520d. The circulation pump 504 is connected to the lower part of the first chamber 513 of the dehydrator 506 via a pipeline 520e passing through the heater 505. The upper part of the first chamber 513 is connected to the circulation pump 504 via the pipeline 520f. The circulatory system is configured to include the circulation pump 504, the pipeline 520e, the first chamber 513 of the dehydrator 506, and the pipeline 520f.

The second chamber 514 of the dehydrator 506 is connected to the condenser 507 via a pipeline 520g. A cooling pipe 516 which is wound multiple times is housed in the condenser 507. The coolant-circulation device 508 is connected to one end of the cooling pipe 516 via a forwarding pipeline 520h. The other end of the cooling pipe 516 is connected to the coolant-circulation device 508 via a returning pipeline 520i. That is, a cooling medium in the coolant-circulation device 508 circulates through the forwarding pipeline 520h, the cooling pipe 516, and the returning pipeline 520i. A pipeline 520j is connected to the upper side wall of the condenser 507. In the pipeline 520j, the vacuum pump 509 and the oil mist trap 510 are interposed in this order. Gas ballast N₂ (indicated by N₂ in the figure) is introduced into the vacuum pump 509. Gas in the condenser 507 is exhausted through the pipeline 520j. A pipeline 520k is connected to the lower part of the condenser 507. In the pipeline 520k, the pump 511 and a second on-off valve 517 are interposed in this order. The water accumulated on the bottom of the condenser 507 is recovered through the pipeline 520k.

A pipeline 520l is branched from the pipeline 520f which is one of the circulatory systems. A third on-off valve (not shown) is interposed near the branched part of the pipeline 520l. The pipeline 520l intersects with the heat recovery device 503. The mixture is treated multiple times in the dehydrator 506, and the treated solution flowing through the pipeline 520f is recovered through the pipeline 520l. A pipeline 520m is branched from the pipeline 520l and the pipeline 520m is connected to the mixture tank 501.

Subsequently, dehydration operation of a mixture obtained by mixing a solvent with water will be described with reference to the apparatus shown in FIG. 24.

The mixture is transferred to the circulation pump 504 via the pipeline 520a, the pipeline 520d, and the pipeline 520f by operating the liquid transfer pump 502. The pipeline 520l is separated from the circulatory system by closing the third on-off valve (not shown). While the liquid transfer pump 502 is operated to transfer the mixture to the circulation pump 504, the circulation pump 504 is operated to allow the mixture to circulate in the first chamber 513, the pipeline 520f of the pipeline 520e, and the dehydrator 506 multiple times. In this cyclic process, when the circulatory system reaches a predetermined amount of the mixture, the first on-off valve 515 is closed to stop the transferring of the mixture to the circulatory system. Further, in the cyclic process, the mixture is heated to a desired temperature by the heater 505. The vacuum pump 509 is operated to evacuate the inside of the second chamber 514 of the dehydrator 506 through the pipeline 520g and to reduce a pressure in the second chamber 514. Simultaneously, the cooling medium from the coolant-circulation device 508 is allowed to circulate in the forwarding pipeline 520h, the cooling pipe 516, and the returning pipeline 520i, thereby cooling the condenser 507. The steam introduced from the second chamber 514 into the condenser 507 is condensed by cooling the condenser 507. The steam becomes water and the water is recovered through the pipeline of 520k.

In such operation, in order to supply the heated mixture to the first chamber 513 of the dehydrator 506, a pressure in the second chamber 514, which is divided from the first chamber 513 by the water removal membrane 512, is reduced. As a result, a pressure difference is generated between the first and second chambers 513 and 514. The water in the mixture evaporates in the first chamber 513 and the evaporated water permeates through the water removal membrane 512 and moves to the second chamber 514.

The mixture is allowed to circulate multiple times in the circulatory system and is dehydrated. After that, the third on-off valve (not shown) is opened to allow the pipeline 520l to communicate with the circulatory system. The treated solution, which is the mixture dehydrated by the operation, is recovered through the pipeline 520l. In the heat recovery device 503, the treated solution flowing through the pipeline 520l is heat-exchanged with the mixture flowing out from the liquid transfer pump 502 into the circulation pump 504, thereby preheating the mixture. When the treated solution flowing through the pipeline 520l is not sufficiently dehydrated, the solution is transferred to the mixture tank 501 via the pipeline 520m branched from the pipeline 520l. The treated solution in the mixture tank 501 and the mixture supplied into the mixture tank 501 are transferred to the circulatory system via the pipeline 520a and the pipeline 520b branched from this pipeline by operating the liquid transfer pump 502.

### <Results>

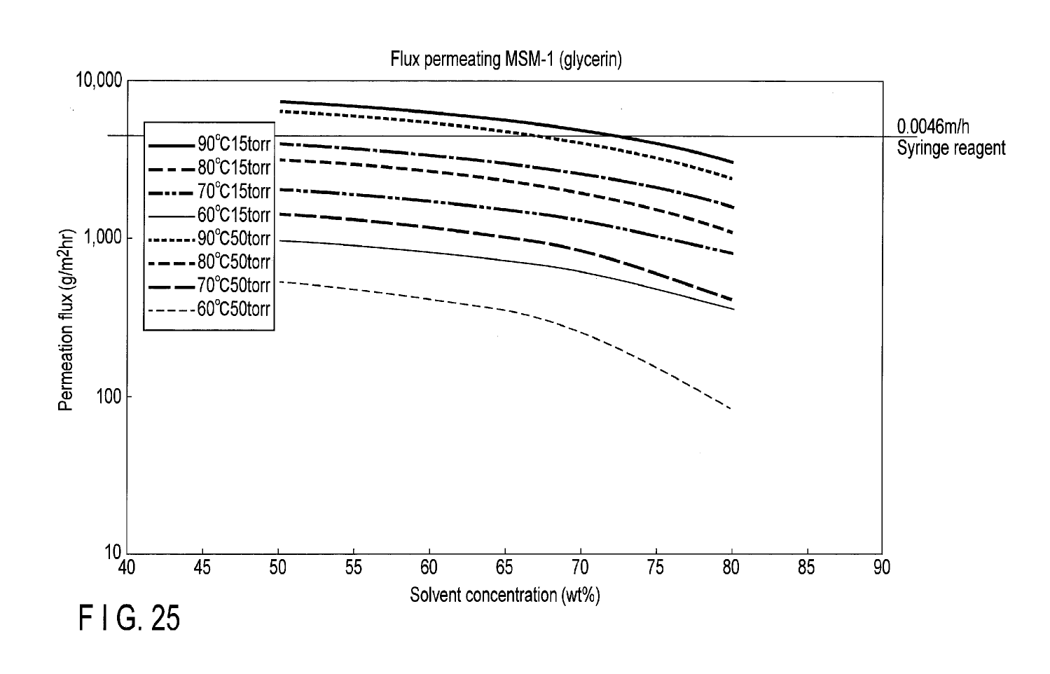

The results obtained from each of the mixtures are shown in FIGS. 25 to 29. In all of the graphs, the horizontal axis represents concentration of a solvent mixed with water, i.e., concentration of glycerin, tert-butanol, ethylene glycol, isopropanol or ethanol in water. The vertical axis represents flux permeating the water removal membrane (zeolite membrane: MSM-1, manufactured by Mitsubishi Chemical Corporation, namely, the flow rate permeating the membrane is indicated by the weight (g/m² hr) per time and unit area. As shown in FIGS. 25 to 29, water separation conditions were set as follows: temperature of each mixture: 90° C., 80° C., 70° C., 60° C. or 90° C.; and degree of vacuum: 15 torr or 50 torr. These results show that the flow rate of glycerin permeating the membrane is higher than the flow rate of the saline solution permeating the membrane. Therefore, it is apparent that glycerin is excellent for use as the working medium.

Further, the flow rate of other solvents permeating the membrane was lower than the flow rate of the saline solution permeating the membrane. This is considered to be because an influence of concentration polarization is significant. Therefore, the flow rate may be improved by using a cross-flow mode. Thus, other solvents may be sufficiently used as the working media.

These figures show the results of syringe tests using each of the solvents.

The result of glycerin will be described with reference to FIG. 25. In the case of glycerin (bp.=290° C., mp.=17.8° C., d=1.26), the average membrane permeation rate in the syringe test at 5 hours was 0.0046 m/h at 20° C. This flux was indicated by the line parallel to the horizontal axis (horizontal line) in the graph of FIG. 25. As a result, the test using MSM-1 shows that it is possible to separate the mixture of water and glycerin under following conditions: concentration: 50 to 70 wt %, temperature: 90° C., pressure: 15 Torr, flux: 0.0046 m/h or more.

It is found that there is a region which keeps the water flow at the power generation side and the water flow at the recovery side the same in a narrow range. On the other hand, in the case of using the data of 5 minutes, the membrane permeation rate of glycerin was 0.0276 m/h, which was a value far larger than that in the graph region in FIG. 25. Therefore, it is found that the amount of the membrane and the capacity of the recovery system need to be increased depending on the above result.

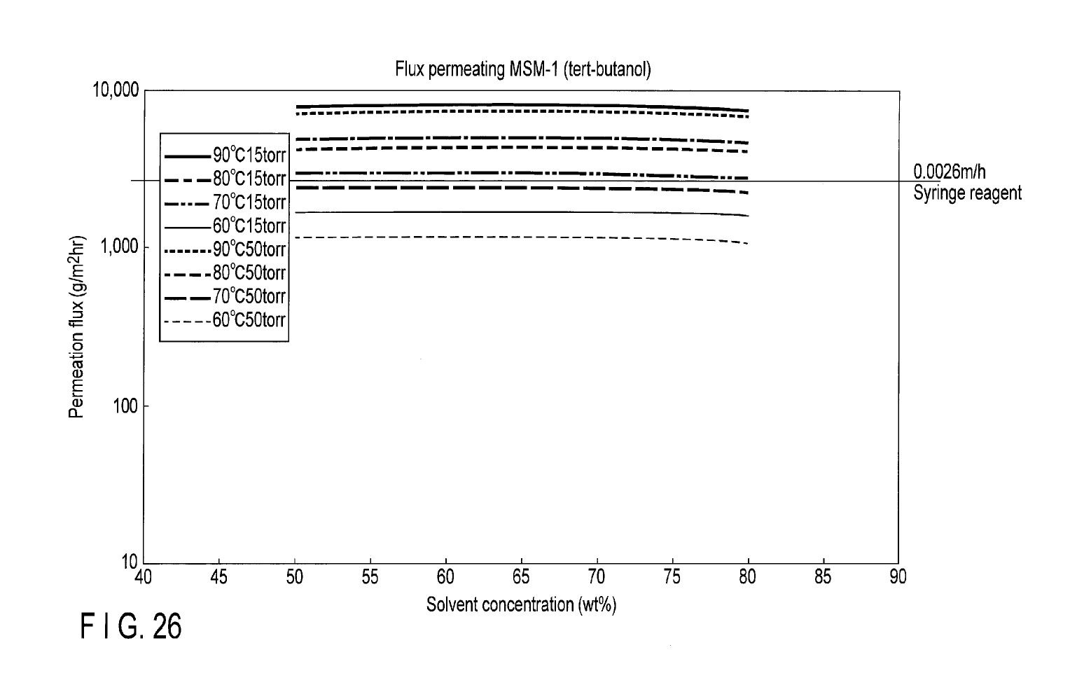

With reference to FIG. 26, tert-butanol will be described. In the case of t-BuOH (bp.=82.4° C., mp.=25.69° C., d=0.78), the average membrane permeation rate in the syringe test at 5 hours was 0.0026 m/h at 20° C. This flux was indicated by the line parallel to the horizontal axis (horizontal line) in the graph of FIG. 26. As a result, the test using MSM-1 shows that it is possible to separate water from the mixture of water and tert-butanol under following conditions: concentration: 50 to 80 wt %, temperature: 90° C., pressure: 15 Torr, flux: 0.0026 m/h or more. Hence, it is found that there is a region which keeps the water flow at the power generation side and the water flow at the recovery side the same.

On the other hand, in the case of using the data of 5 minutes, the membrane permeation rate of t-BuOH was 0.0184 m/h, which was a value far larger than that in the graph region in FIG. 26. Therefore, it is suggested that the amount of the membrane and the capacity of the recovery system need to be increased depending on the above result.

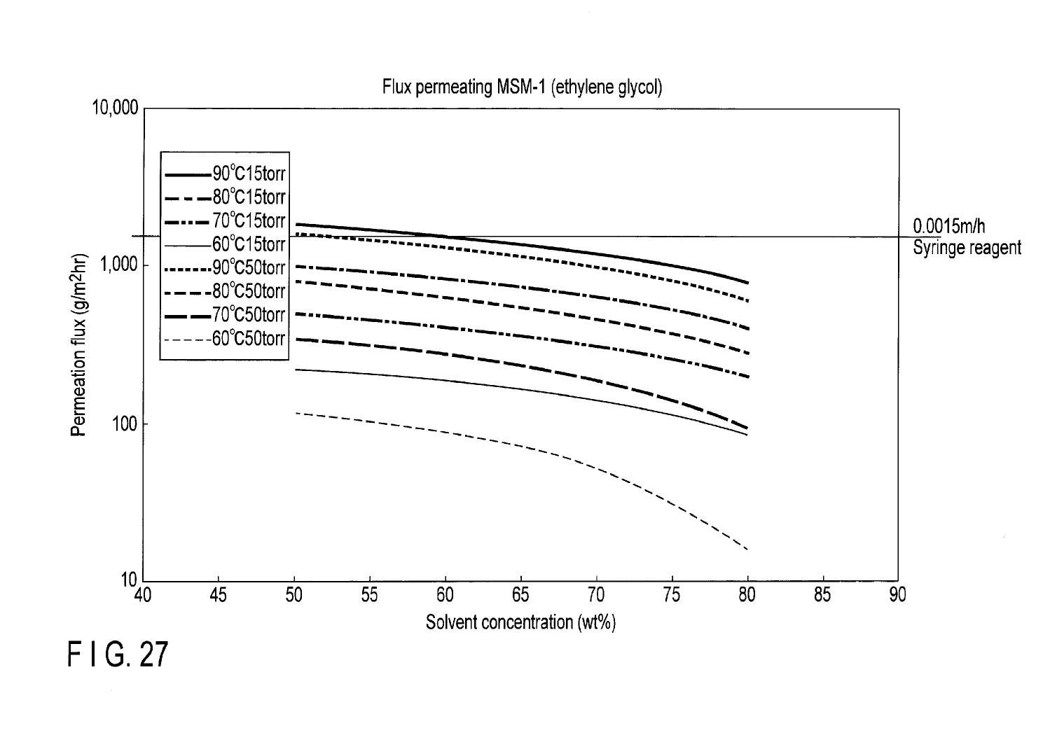

Ethylene glycol will be described with reference to FIG. 27. In the case of ethylene glycol (bp.=197.3° C., mp.=−12.9° C., d=1.11), the average membrane permeation rate in the syringe test at 5 hours was 0.0013 m/h at 20° C. This flux was indicated by the line parallel to the horizontal axis (horizontal line) in the graph of FIG. 27. As a result, the test using MSM-1 shows that it is possible to separate water from the mixture of water and ethylene glycol under following conditions: concentration: 50 to 63 wt %, temperature: 90° C., pressure: 15 Torr, flux: 0.0013 m/h or more. It is found that there is a region which keeps the water flow at the power generation side and the water flow at the recovery side the same in a narrow range.

On the other hand, in the case of using the data of 5 minutes, the membrane permeation rate of ethylene glycol is 0.0071 m/h, which is a value far larger than the horizontal line parallel to the uppermost horizontal axis of the graph shown in FIG. 27. Therefore, it is found that the amount of the membrane and the capacity of the recovery system need to be increased depending on the above result.

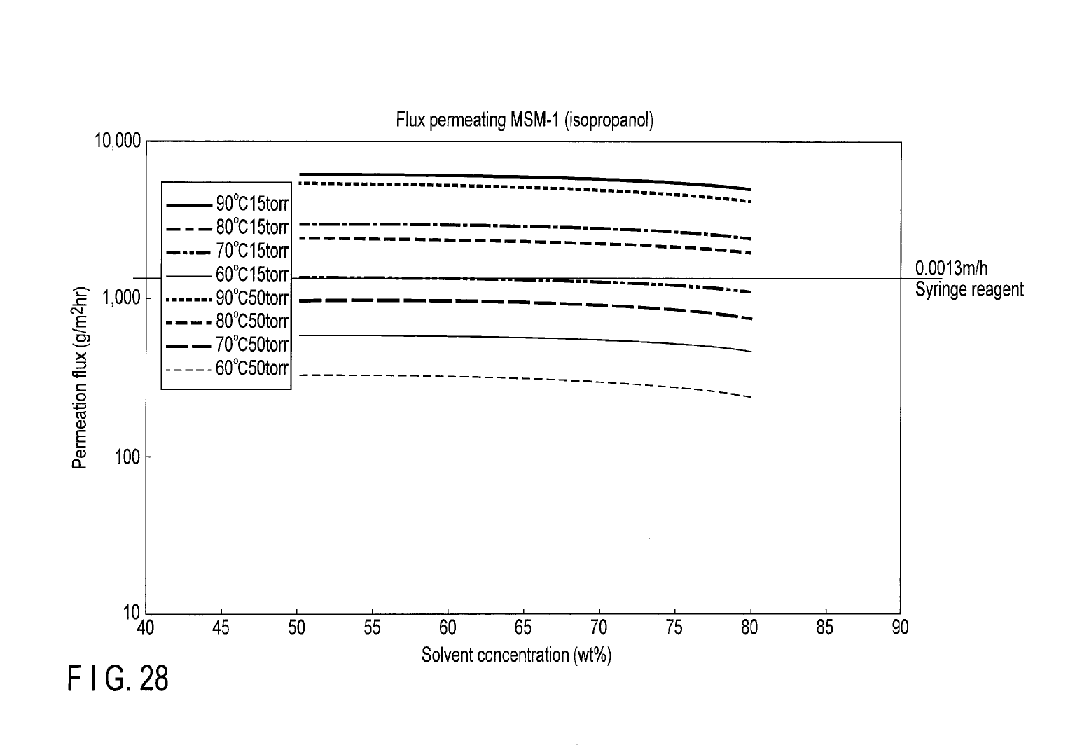

Isopropanol (IPA) will be described with reference to FIG. 28. In the case of IPA (bp.=82.4° C., mp.=−89.5° C., d=0.78), the average membrane permeation rate in the syringe test at 5 hours was 0.0013 m/h at 20° C. This flux was indicated by the line parallel to the horizontal axis (horizontal line) in the graph of FIG. 28. As a result, the test using MSM-1 shows that it is possible to separate water from the mixture of water and isopropanol under following conditions: concentration: 50 to 80 wt %, temperature: 90° C., pressure: 15 Torr, flux: 0.0013 m/h or more. Thus, it is found that there is a region which keeps the water flow at the power generation side and the water flow at the recovery side the same.

On the other hand, in the case of using the data of 5 minutes, the membrane permeation rate of IPA is 0.0041 m/h. Therefore, it is found that all parts of 90° C. in the graph shown in FIG. 28 are included in the above region, thereby keeping the water flow at the power generation side and the water flow at the recovery side the same.

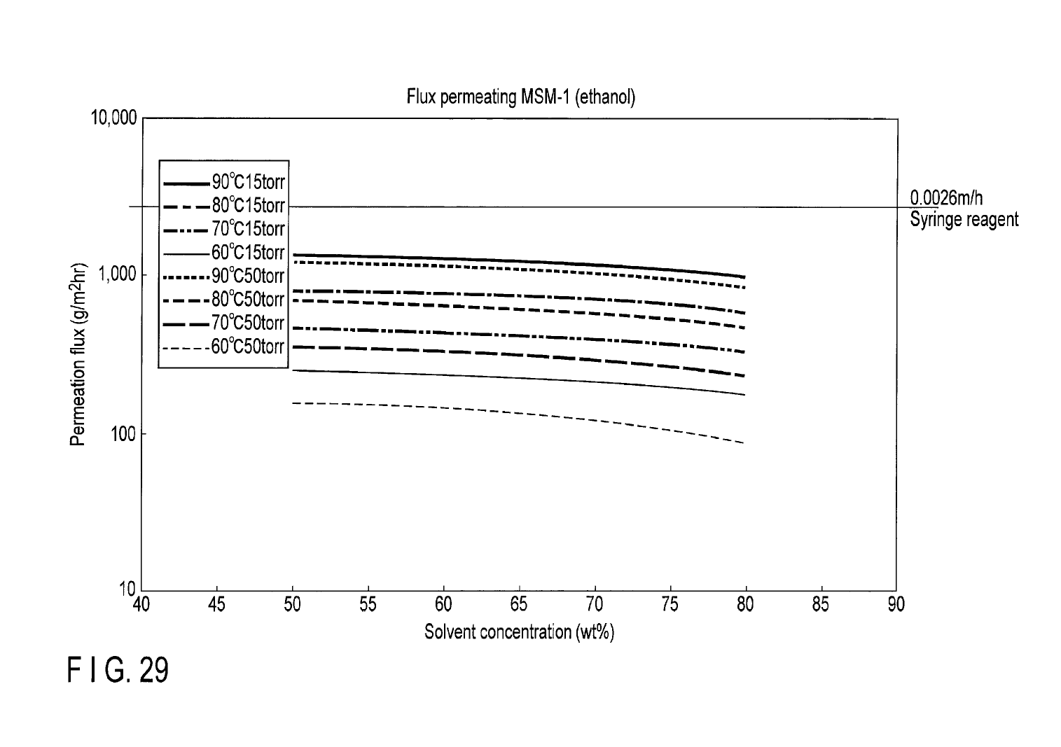

Ethanol will be described with reference to FIG. 29. In the case of EtOH (bp.=78.4° C., mp.=−114.3° C., d=0.79), the average membrane permeation rate in the syringe test at 5 hours was 0.0026 m/h at 20° C. This flux was indicated by the line parallel to the horizontal axis (horizontal line) in the graph of FIG. 29. As a result, the test using MSM-1 shows that it is impossible to separate water from the mixture of water and ethanol at a flux of 0.0026 m/h or more in any region. Therefore, in the case of ethanol, it is found that the amount of the membrane to be used and the capacity of the recovery system need to be increased depending on the above result.

### Conclusion

The power generation amount of osmotic pressure power generation can be roughly estimated in the same manner as in the case of hydraulic power generation. This is based on the premise that the head of water can be predicted from osmotic pressure as shown in Formula 2.

Water power [W]=head of water [m]×flow [m³-/s]×9.8 [m/s²] (Formula 2)

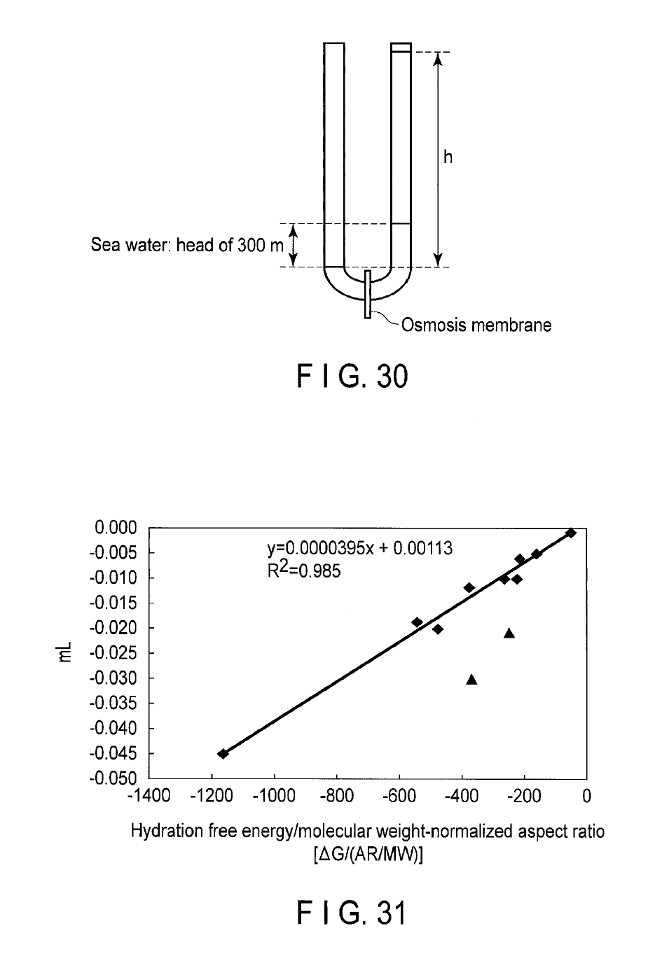

For example, in the case of sea water having a concentration which is equal to 3.5 wt % of saline solution, the osmotic pressure is close to 30 atm and thus an osmotic pressure corresponding to a head of water of about 300 m is obtained. Similarly to this, in the case of using the solvent used in Example 6 in water as the solute, the height of the water column pushed up can be calculated from data of osmotic pressure (refer to FIG. 30).

The dimension can be calculated by directly converting the water volume of flow to the weight based on Formulae:

[W]=[J/s]=[Nm/s]; and

[N]=[kg]×[m/s²].

However, in the case of water mixed in the solvent, it is necessary to take into consideration specific gravity for precise calculation.

On the other hand, regarding the degree of osmotic pressure, an appropriate theoretical formula does not exist in a concentration range of more than 50 wt % used herein. Therefore, the van't Hoff formula used in a low concentration range was directly employed. This result was shown in Table 1. In this regard, the maximum concentration was the maximum concentration value at an acceptable level by the same membrane area in FIGS. 25 to 29. In this case, the average flow rate at 5 hours in the syringe test was employed for the amount of permeated water.

TABLE 1
Calculation of osmotic pressure of various solvents

| | | | | | | | | Van't Hoff | |
|---|---|---|---|---|---|---|---|---|---|
| | | Density of | Wt % of | Water | Solvent | Total | | osmotic | Water |
| Component A | Component B | component B | component B | amount | amount | volume | Solute | pressure | high |
| (MW.) | (MW.) | (g/ml) | (%) | (g) | (g) | (L) | (mol/L) | (atm) | (m)* |
| Water(18) | NaCl | | 3.5 | 1000 | 35 | 1.0 | 0.60 | 29 | 146 |
| Water(18) | IPA (60.1) | 0.78 | 80 | 200 | 800 | 1.23 | 10.86 | 265 | 1327 |
| Water(18) | Glycerin | 1.26 | 70 | 300 | 700 | 0.86 | 8.88 | 217 | 1085 |
| | (92.1) | | | | | | | | |
| Water(18) | t-BuOH | 0.78 | 80 | 200 | 800 | 1.23 | 8.81 | 215 | 1076 |
| | (74.1) | | | | | | | | |
| Water(18) | Ethylene | 1.1 | 63 | 370 | 630 | 0.94 | 11.12 | 272 | 1359 |
| | glycol | | | | | | | | |
| | (62.1) | | | | | | | | |

*The maximum head of water is corresponding to the half of the osmotic pressure

The head of water was calculated from the osmotic pressure value obtained as described above, and this value and the flux of the syringe test were used to calculate the power generation amount. In this case, the membrane area was 37 m². This is a membrane area of an osmosis membrane element (commercially available from Toray Industries, Inc.).

Setting for the circulation pump and the vacuum pump (model number: DTC-22) used for operation of the system was carried out. The ultimate vacuum was sufficient even if it was 50 Torr as shown in the experiments of FIGS. 25 to 29. Accordingly, as shown in Table 1 above, it is not necessary to use the electric power required to achieve 7.6 Torr. However, this point was subtracted as rated power in calculation. On the premise of circulating water in an amount ten times higher than the amount of permeated water by the circulation pump with the cross flow mode, a necessary pump (model number: MD-10 K-N) was selected, and the electricity was calculated as rated power. The results are shown in Table 2.

TABLE 2
Consumed amount of electricity

| | | | | |
|---|---|---|---|---|
| Recovery of solvent | Vacuum pump DTC-22 → | 1000 | Pa | 40 |
| | Ultimate vacuum 0.01 atm | | | |
| | (7.6 Torr) | | | |
| Amount of water transfer | Ten times higher than the | 1.6 | m³/h | 53 |
| | amount of permeated water | | | |
| | (MD-10K-N) | | | |
| Amount of solvent | Ten times higher than the | 1.6 | m³/h | 53 |
| transfer | amount of permeated water | | | |

The amount of electricity to be obtained was calculated by subtracting the power of the pump required for solution transfer or vacuum suction from the power generation amount calculated as described above. In this case, in the embodiment using the apparatus of FIG. 24, the heating part was determined to use exhaust heat at 90° C. without any limitation and it was not subtracted in calculation. The results are shown in Table 3.

TABLE 3
Amount of electricity to be obtained

| Solvent | | Heating | Vacuum | | | Electric power | Consumed | Net electric |
|---|---|---|---|---|---|---|---|---|
| (working | Concentration | temperature | range | | | generation | amount | power generation |
| medium) | range (wt %) | range (° C.) | (Torr) | Used data | flux | amount (w) | (w) | amount (w) |
| IPA | 50-80 | 70-90 | 15-50 | Average at 5 hours | 0.0013 | 174 | 252 | −78 |
| IPA | 50-80 | 70-90 | 15-50 | At 5 minutes | 0.0041 | 548 | 252 | 296 |
| Glycerin | 50-70 | 90 | 15 | Average at 5 hours | 0.0055 | 601 | 252 | 349 |
| Glycerin | 50-70 | 90 | 15 | At 5 minutes | 0.031 | 3388 | 252 | 3136 |
| t-BOH | 50-80 | 70-90 | 15-50 | Average at 5 hours | 0.0026 | 282 | 252 | 30 |
| t-BOH | 50-80 | 70-90 | 15-50 | At 5 minutes | 0.0184 | 1994 | 252 | 1742 |
| Ethylene | 50-63 | 90 | 15 | Average at 5 hours | 0.0015 | 205 | 252 | −47 |
| glycol | | | | | | | | |
| Ethylene | 50-63 | 90 | 15 | At 5 minutes | 0.0071 | 972 | 252 | 720 |
| glycol | | | | | | | | |

These results show the following. In the syringe test data, when the values for the first 5 minutes (low concentration polarization) were observed, sufficient outputs were obtained in many of the solvents. However, when the average at 5 hours (including the concentration polarization effect) was observed, only glycerin showed the value producing a surplus in obtaining electricity.

When comprehensively evaluating the above results, it is clear that particularly glycerin and t-BuOH are excellent as the working medium. However, the possibility of other solvents as the working media was suggested.

In the van't Hoff formula used for calculation, the head of water is calculated from the osmotic pressure, thereby predicting the hydraulic power generation amount. Based on the result, it is possible to provide a working medium which uses various types of hyperosmotic solutions. Further, it is suggested that it is possible to provide a circulatory osmotic pressure power generation method and a circulatory osmotic pressure power generation system which use the working medium. Therefore, it is revealed that the embodiment can provide a circulatory osmotic pressure power generation system that is operable at low cost.

### Example 7

The hyperosmotic solution used in the water treatment system according to the embodiment was searched. To achieve this, physicochemical parameters of several solvents were determined based on calculation and well-known references. Specifically, they were determined by referring to well-known reference values for molecular weight, boiling point, melting point, specific gravity, viscosity, surface tension, refractive index, dielectric constant, standard vaporization enthalpy, molar volume, molar concentration, and solubility parameter. Change of hydration free energy in solvent, aspect ratio (ratio of the length and diameter of the minimum cylinder to accommodate a molecule), molecular weight-normalized aspect ratio (obtained by dividing the aspect ratio by the molecular weight), ovality, molecular surface area (based on van der Waals radius), molecular weight-normalized molecular surface area (obtained by dividing the molecular surface area by the molecular weight), molecular volume (based on van der Waals radius), and molecular volume to normalize molecular weight (obtained by dividing the molecular volume by the molecular surface area) were determined by the quantum chemical calculation at the SMD (water)/M05-2 X/MIDI! 6D level. Further, change of solvation free energy in water, change of solvation free energy in solvent, and molar volume were determined by the quantum chemical calculation at the B3 LYP/TZVP level. Gaussian 09 rev.C.01 was used for quantum chemical calculation.

Subsequently, the solvents which were considered to be usable as the hyperosmotic solution were selected and subjected to the syringe test in the following manner. As a result, the correlation between the suction amount at 5 minutes and the physicochemical parameter was confirmed.

### (1) Syringe Test

A syringe test device was fabricated in the same manner as in Example 1. A syringe test device 216 was produced in accordance with the procedure (1) of Example 1. The solvents shown in Table 4 below, i.e., dimethyl sulfoxide (DMSO), dimethylformamide (DMF), acetonitrile, 2-butoxyethanol (2BE), ethylene glycol, glycerin, 2,2,2-trifluoroethanol, N-methyl pyrrolidone (NMP), isopropanol (IPA), n-butanol (n-BuOH), and t-butanol (t-BuOH) were injected to the first syringe 211. Fresh water was injected to the second syringe 212 (shown in FIG. 19 (c)). During steps (S31) and (S32) in FIG. 19 (a), the liquids used for the test were injected to the syringes 211 and 212, respectively. After that, the first syringe 211 was arranged vertically so as to be located in an upper section of the second syringe 212, they were let stand at 25° C. under a pressure of 1 atm. After 5 minutes of the process, the scale of the first syringe 211 was read after 5 minutes and defined as the suction amount (mL) at 5 minutes.

### (2) Results

The syringe test results are shown in Table 4.

TABLE 4

| | Suction amount for |
|---|---|
| Solvent | 5 minutes [mL] |
| Dimethyl sulfoxide (DMSO) | 0.020 |
| Dimethylformamide (DMF) | 0.006 |
| Acetonitrile | 0.001 |
| 2-butoxyethanol (2BE) | 0.010 |
| Ethylene glycol | 0.012 |
| Glycerin | 0.045 |
| 2,2,2,-trifluoroethanol | 0.030 |
| N-methyl pyrrolidone (NMP) | 0.019 |
| Isopropanol (IPA) | 0.010 |
| n-butanol (nBuOH) | 0.005 |
| t-butanol (tBuOH) | 0.021 |

Ethylene glycol, glycerin, and n-BuOH were measured only once. In the case of 2-butoxyethanol (2BE), the same test was repeated 6 times. The average of the test results are shown. In the case of other solvents, the same test was performed 3 times and the average of the test values is shown. In the case of repeating the test more than once, new syringe test devices were fabricated and used for each of the tests.

The correlation between the results of syringe tests and physicochemical parameters was examined. As a result, it is found that there is a correlation between the migration of water to the first syringe 211, (i.e., the suction amount) and the hydration free energy per molecular weight-normalized aspect ratio.

FIG. 31 is a graph showing the suction amount of each of the solvents shown in Table 4 for 5 minutes and the relationship between the suction amount and the hydration free energy per molecular weight-normalized aspect ratio. In FIG. 31, as for each of the solvents shown in Table 4, a value of “hydration free energy/molecular weight-normalized aspect ratio [ΔG/(AR/MW)]” was plotted on the X-axis and a value of the suction amount for up to 5 minutes obtained by the syringe test was plotted on the Y-axis. In this regard, in FIG. 31, two plots indicated by black triangles far away from other plots were assumed to be caused by an influence by the parameter which was not taken into consideration this time, and they were deleted. A regression equation was calculated from this graph and used as the empirical equation to estimate the result of the syringe test.

Based on the empirical equation to estimate the result of the syringe test, the draw solution, i.e., a preferable solvent as the hyperosmotic solution was examined. The suction amount of glycerin for 5 minutes was higher those of the solvents shown in Table 4. Based on this amount, the predicting performance for other substances in polyalcohol to which glycerin belongs was calculated. The results are shown in Table 5.

TABLE 5
Predicting performance for polyalcohol (sugar alcohol)

| | | | | | | Estimated |
|---|---|---|---|---|---|---|
| | | | | | | suction amount |
| Polyalcohol | n | MW | AR | ΔG | ΔG/(AR/MW) | [mL] |
| Ethylene glycol | 0 | 62.07 | 1.45 | −8.80 | −377 | 0.014 |
| Glycerin | 1 | 92.09 | 1.18 | −14.90 | −1163 | 0.04 |
| Xylitol | 3 | 152.15 | 1.85 | −19.67 | −1618 | 0.063 |
| Sorbitol | 4 | 182.17 | 1.96 | −20.19 | −1877 | 0.073 |
| Mannitol | 4 | 182.17 | 1.85 | −18.32 | −1804 | 0.070 |
| Perseitol | 5 | 212.20 | 1.96 | −27.11 | −2935 | 0.115 |
| Volemitol | 5 | 212.20 | 1.79 | −18.20 | −2158 | 0.084 |
| D-erythro-D-galacto-octitol | 6 | 242.23 | 2.31 | −25.24 | −2647 | 0.103 |

MW Molecular weight,
AR Aspect ratio,
ΔG Hydration free energy change

As shown in Table 5, the estimated suction amount of glycerin was 0.045 mL, and this value was equal to an actual measured value of 0.045 mL shown in Table 5. Accordingly, the reliability of the estimated empirical formula was confirmed. There was a significant difference in predicting performance for polyalcohol between ethylene glycol: n=0 (estimated suction amount: 0.014 mL) and glycerin: n=1 (estimated suction amount: 0.045). In the range of n=1 to n=6, the estimated suction amount increases depending on the concentration. This result suggests that the compound of Formula 1 as the hyperosmotic solution, i.e., polyalcohol can be preferably used.

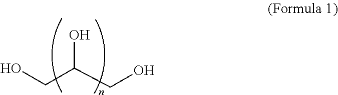

Here, n represents an integer of 0 or more. When n represents 0, 1 or 3, the compound of Formula 1 is ethylene glycol, glycerin or xylitol. The compound of Formula 1 (n=4) is sorbitol or mannitol. Further, the compound of Formula 1 (n=5) is perseitol or volemitol. The compound of Formula 1 (n=6) is, for example, D-erythro-D-galacto-octitol. Preferably, n represents an integer of 1 or more (n 1).

In Table 5 above, the estimated suction amount of polyalcohol having a larger value of n among polyalcohols of Formula 1 tended to increase. Although a difference in estimated suction amount between perseitol and volemitol (n=5) was observed, the estimated suction amounts thereof were larger than the estimated suction amount of mannitol (n=4). The estimated suction amount of D-erythro-D-galacto-octitol (n=6) was larger than that of volemitol, and smaller than that of perseitol. In conclusion, based on the quantum chemical calculation, it is confirmed that the estimated suction amount tends to increase when n is from 0 to 6, and tends to significantly increase when n is from 1 to 5. Therefore, it doesn't mean that a larger value of n is simply preferred. It is necessary to note that based on the colligative property, if molecules have the same mass percent concentration, the quantity of the molecule having a smaller molecular weight increases and this is advantageous.

The above results suggest that polyalcohol can be used as an excellent draw solution. Among polyalcohols having Formula 1, polyalcohol (n≧1) is preferred.

Thus, it is found that the osmotic pressure difference is efficiently generated by using various types of hyperosmotic solutions as the draw solution whereby water can be sucked into the draw solution. Further, a diluted draw solution, which is a mixture containing water sucked by an osmotic pressure generator and a hyperosmotic solution, is dehydrated in a vaporization-separation unit, whereby it is possible to easily recover water with high purity. According to the embodiments, it is suggested that the water treatment system such as a circulatory osmotic pressure power generation system, a desalination system, or a water purification system is operable at low cost.

The embodiment of the present invention has been hereinabove explained. However, this embodiment is presented as an example, and is not intended to limit the scope of the invention. These new embodiments can be embodied in various other forms, and various kinds of omissions, replacements, and changes can be made without deviating from the gist of the invention. These embodiments and the modifications thereof are included in the scope and the gist of the invention, and are included in the invention described in the claims and the scope equivalent thereto.

What is claimed is:

1. A water treatment method using a working medium which includes a water-containing solution to be treated and a draw solution, wherein the draw solution is a hyperosmotic solution which generates an osmotic pressure difference with water,
the method comprising:
(1) in an osmotic pressure generator which includes a first chamber and a second chamber compartmentalized by an osmosis membrane, generating a flux of a mixture containing the water and the hyperosmotic solution by an osmotic pressure difference generated between the solution to be treated which is accommodated in the first chamber and the draw solution which is accommodated in the second chamber;
(2) in a vaporization-separation unit which includes a third chamber and a fourth chamber compartmentalized by a zeolite membrane, transferring the flux of the mixture to the third chamber;
(3) transferring water permeated through the zeolite membrane from the third chamber to the fourth chamber by a pressure difference between the fourth chamber and the third chamber to separate the water from the draw solution; and
(4) transferring the draw solution which is separated by the vaporization-separation unit to the second chamber of the osmotic pressure generator.

2. The method of claim 1, wherein the water treatment includes desalinating and/or purifying the solution to be treated, further comprising recovering the water separated by the vaporization-separation unit.

3. The method of claim 1, wherein the water treatment includes generating power, further comprising a turbine which is rotated by flux of the mixture flowing out from the osmotic pressure generator; a line which transfers the mixture after rotating the turbine to the vaporization-separation unit; and a line which transfers water separated by the vaporization-separation unit to the first chamber of the osmotic pressure generator.

4. The method of claim 1, wherein the water treatment includes generating power and desalinating and/or purifying the solution to be treated, further comprising a turbine which is rotated by flux of the mixture flowing out from the osmotic pressure generator; a line which transfers the mixture after rotating the turbine to the vaporization-separation unit; and a recovery tank which accommodates water separated by the vaporization-separation unit.

5. The method of claim 1, wherein the zeolite membrane is a chabazite-type zeolite.

6. The method of claim 1, wherein the water is separated from the draw solution by a pervaporation method.

7. The method of claim 1, wherein the draw solution is alcohol or polyalcohol.

8. The method of claim 1, wherein the draw solution is selected from the group consisting of tert-butanol, isopropyl alcohol, polyalcohol including a compound represented by Formula 1 below, and an aqueous solution thereof; 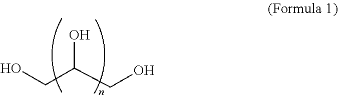
where n represents an integer of 0 or more.

9. The method of claim 1, further comprising applying heat from exhaust heat to the vaporization-separation unit.

10. A water treatment system configured to use a working medium which includes a water-containing solution to be treated and a draw solution to treat the solution to be treated, which comprises:
(1) the working medium in which the draw solution is a hyperosmotic solution which generates an osmotic pressure difference with water;
(2) an osmotic pressure generator which includes a first chamber and a second chamber compartmentalized by an osmosis membrane and which generates a flux of a mixture containing the water and the draw solution by an osmotic pressure difference generated between the solution to be treated accommodated in the first chamber and the draw solution accommodated in the second chamber;
(3) a vaporization-separation unit which includes a third chamber and a fourth chamber compartmentalized by a zeolite membrane, which accommodates the mixture in the third chamber, and which transfers water permeated through the zeolite membrane from the third chamber to the fourth chamber by a pressure difference between the fourth chamber and the third chamber, thereby separating the mixture into the water and the draw solution;
(4) a first line configured to transfer the water separated by the vaporization-separation unit to the first chamber of the osmotic pressure generator; and
(5) a second line configured to transfer the draw solution separated by the vaporization-separation unit to the second chamber of the osmotic pressure generator.

11. The system of claim 10, wherein the water treatment includes desalinating and/or purifying the solution to be treated, further comprising a recovery tank which accommodates water separated in the vaporization-separation unit.

12. The system of claim 10, wherein the water treatment includes generating power, further comprising a turbine which is rotated by flux of the mixture flowing out from the osmotic pressure generator and a line which transfers the mixture after rotating the turbine to the vaporization-separation unit.

13. The system of claim 10, wherein the water treatment includes generating power and desalinating and/or purifying the solution to be treated, further comprising a turbine which is rotated by flux of the mixture flowing out from the osmotic pressure generator, a line which transfers the mixture after rotating the turbine to the vaporization-separation unit, and a recovery tank which accommodates the water separated in the vaporization-separation unit.

14. The system of claim 10, wherein the zeolite membrane is a chabazite-type zeolite.

15. The system of claim 10, wherein the draw solution is separated from the water by the pervaporation method.

16. The system of claim 10, wherein the draw solution is selected from the group consisting of tert-butanol, isopropyl alcohol, polyalcohol including a compound represented by Formula 1 below, and an aqueous solution thereof; 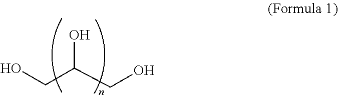
where n represents an integer of 0 or more.

17. A water treatment apparatus comprising:
an osmotic pressure generator which includes an osmosis membrane, a first chamber and a second chamber which are compartmentalized by the osmosis membrane, the first chamber being accommodated a water-containing solution to be treated, and the second chamber accommodated a draw solution which generates an osmotic pressure difference with water;
a vaporization-separation unit which is introduced a mixture containing the draw solution flowing out from the osmotic pressure generator and water drawn by the draw solution, and which separates the mixture into water and the draw solution by permeating the water in the mixture through a zeolite membrane by a pressure difference; and
a line configured to transfer the draw solution separated by the vaporization-separation unit to the second chamber of the osmotic pressure generator.

18. The apparatus of claim 17, wherein the water treatment includes desalinating and/or purifying the solution to be treated, further comprising a recovery tank which accommodates the water separated in the vaporization-separation unit.

19. The apparatus of claim 17, wherein the water treatment includes generating power, further comprising a turbine which is rotated by flux of the mixture flowing out from the osmotic pressure generator, a line configured to transfer the mixture after rotating the turbine to the vaporization-separation unit, and a line configured to transfer water separated by the vaporization-separation unit to the first chamber of the osmotic pressure generator.

20. The apparatus of claim 17, wherein the water treatment includes generating power and desalinating and/or purifying the solution to be treated, further comprising a turbine which is rotated by flux of the mixture flowing out from the osmotic pressure generator, a line configured to transfer the mixture after rotating the turbine to the vaporization-separation unit. And a recovery tank which accommodates the water separated in the vaporization-separation unit.
